(19) United States
(12) Patent Application Publication
(10) Pub. No.: US 2026/0360060 A1
(43) Pub. Date: Nov. 12, 2026

(54) INFORMATION PROCESSING APPARATUS AND METHOD

(71) Applicant: SONY GROUP CORPORATION, TOKYO (JP)

(72) Inventors: TAKUMI TSURU, TOKYO (JP); RYOHEI TAKAHASHI, TOKYO (JP)

(21) Appl. No.: 19/490,374

(22) PCT Filed: Jun. 10, 2024
(86) PCT No.: PCT/JP2024/020985

§ 371 Date: Dec. 5, 2025

(30) Foreign Application Priority Data
Jun. 28, 2023 (JP) 2023-105684

(51) Int. Cl. G06T 13/40; G06T 17/00

(52) U.S. Cl. CPC G06T 13/40; G06T 17/00; G06T 2210/61; G06T 2213/04

(57) ABSTRACT

The present disclosure relates to an information processing apparatus and method that enable an increase in a load of reproduction processing to be suppressed while suppressing lowering of quality of a user experience. A definition of a static 3D model indicating an appearance of a 3D model is set, a definition of skeleton information indicating a movement structure of the 3D model is set independently of the static 3D model, and content including the static 3D model and the skeleton information that correspond to the set definitions and skin weight information indicating a correspondence relationship between the appearance and the movement structure is reproduced. Further, control information that is used for controlling supply of the content and expresses, independently of one another, variations of the definition of the static 3D model, variations of the definition of the skeleton information, and variations of the skin weight information is supplied. The present disclosure can be applied to, for example, an information processing apparatus, an electronic device, an information processing method, a program, or the like.

### TECHNICAL FIELD

The present disclosure relates to an information processing apparatus and method, more particularly, to an information processing apparatus and method that are capable of suppressing an increase in a load of reproduction processing while suppressing lowering of quality of a user experience.

### BACKGROUND ART

From the past, there has been a Skinned model as a 3D model that expresses a three-dimensional shape of an object. Since a load of reproduction processing of such a 3D model is large, a method of reducing a load has been demanded. For example, there is a method of reducing a load of reproduction processing by lowering a definition of an appearance and movement structure of a 3D model in accordance with a distance from a viewpoint (see, for example, Patent Literature 1). In the case of this method, however, only control that is based on the distance from a viewpoint can be performed, and thus it has been difficult to reduce the load of the reproduction processing in a case where a 3D model is located close to the viewpoint, for example. In addition, since it is necessary to lower quality of the appearance in order to reduce the load of the reproduction processing, there has been a fear that quality of a user experience will be lowered. Thus, this method has not always been the best.

In contrast, there is a method of reducing a load of reproduction processing by lowering a definition of motion data (a definition of a movement) for moving a Skinned model (see, for example, Non-Patent Literature 1).

### CITATION LIST

### Patent Literature

Patent Literature 1: Japanese Patent Application Laid-open No. 2012-212246

### Non-Patent Literature

Non-Patent Literature 1: Level-of-Detail of Motion on Crowd Scene by Shingo Hasegawa, Koji Nishio, and Ken-ichi Kobori, FIT2010 (Forum on Information Technology 2010), https://www.ieice.org/publications/conference-FIT-DVDs/FIT2010/pdf/I/I_052.pdf

### DISCLOSURE OF INVENTION

### Technical Problem

In the case of this method, however, there has been a fear that, since an amount of information of the Skinned model does not change, and/or the like, a reduction in the load of the reproduction processing will be limited. In other words, also this method has not always been the best. For these reasons, there has been a demand for another method for suppressing an increase in the load of the reproduction processing while suppressing lowering of quality of a user experience.

The present disclosure has been made in view of the circumstances as described above, and aims at enabling an increase in the load of the reproduction processing to be suppressed while suppressing lowering of quality of a user experience.

### Solution to Problem

An information processing apparatus according to an aspect of the present technology is an information processing apparatus including: a control information supply unit which supplies control information for controlling supply of content including a static 3D model indicating an appearance of a 3D model, skeleton information indicating a movement structure of the 3D model, and skin weight information indicating a correspondence relationship between the appearance and the movement structure; and a content supply unit which supplies the content including the static 3D model having a definition that has been requested based on the control information, the skeleton information having a definition that has been requested based on the control information, and the skin weight information that has been requested based on the control information, in which the control information expresses, independently of one another, variations of the definition of the static 3D model, variations of the definition of the skeleton information, and variations of the skin weight information.

An information processing method according to an aspect of the present technology is an information processing method including: supplying control information for controlling supply of content including a static 3D model indicating an appearance of a 3D model, skeleton information indicating a movement structure of the 3D model, and skin weight information indicating a correspondence relationship between the appearance and the movement structure; and supplying the content including the static 3D model having a definition that has been requested based on the control information, the skeleton information having a definition that has been requested based on the control information, and the skin weight information that has been requested based on the control information, in which the control information expresses, independently of one another, variations of the definition of the static 3D model, variations of the definition of the skeleton information, and variations of the skin weight information.

An information processing apparatus according to another aspect of the present technology is an information processing apparatus including: a static 3D model definition setting unit which sets a definition of a static 3D model indicating an appearance of a 3D model; a skeleton information definition setting unit which sets, independently of the static 3D model, a definition of skeleton information indicating a movement structure of the 3D model; and a content reproduction unit which reproduces content including the static 3D model and the skeleton information that correspond to the set definitions and skin weight information indicating a correspondence relationship between the appearance and the movement structure.

An information processing method according to another aspect of the present technology is an information processing method including: setting a definition of a static 3D model indicating an appearance of a 3D model; setting, independently of the static 3D model, a definition of skeleton information indicating a movement structure of the 3D model; and reproducing content including the static 3D model and the skeleton information that correspond to the set definitions and skin weight information indicating a correspondence relationship between the appearance and the movement structure.

In the information processing apparatus and method according to the aspect of the present technology, control information for controlling supply of content including a static 3D model indicating an appearance of a 3D model, skeleton information indicating a movement structure of the 3D model, and skin weight information indicating a correspondence relationship between the appearance and the movement structure is supplied, and the content including the static 3D model having a definition that has been requested based on the control information, the skeleton information having a definition that has been requested based on the control information, and the skin weight information that has been requested based on the control information is supplied. In the control information, variations of the definition of the static 3D model, variations of the definition of the skeleton information, and variations of the skin weight information are expressed independently of one another.

In the information processing apparatus and method according to the another aspect of the present technology, a definition of a static 3D model indicating an appearance of a 3D model is set, a definition of skeleton information indicating a movement structure of the 3D model is set independently of the static 3D model, and content including the static 3D model and the skeleton information that correspond to the set definitions and skin weight information indicating a correspondence relationship between the appearance and the movement structure is reproduced.

### BRIEF DESCRIPTION OF DRAWINGS

FIG. 1 A diagram for explaining a Skinned model.

FIG. 2 A diagram for explaining control of a definition of an appearance.

FIG. 3 A diagram for explaining a general outline of control of a definition of a movement.

FIG. 4 A diagram showing an example of motion data.

FIG. 5 A diagram for explaining control of the definition of a movement.

FIG. 6 A diagram showing an example of a control method for a definition related to a 3D model.

FIG. 7 A diagram showing an example of a general outline of control of the definition related to a 3D model.

FIG. 8 A diagram showing an example of a general outline of control of the definition of a 3D model.

FIG. 9 A diagram showing an example of skin weight information.

FIG. 10 A diagram showing an example of the skin weight information.

FIG. 11 A diagram showing an example of the skin weight information.

FIG. 12 A diagram showing an example of the skin weight information.

FIG. 13 A diagram for explaining an example of a movement.

FIG. 14 A diagram for explaining reproduction processing.

FIG. 15 A diagram for explaining a load in a case of a highest definition.

FIG. 16 A diagram showing an example of lowering the definition of a movement.

FIG. 17 A diagram showing an example of the load in the case of lowering the definition of a movement.

FIG. 18 A diagram showing an example of lowering a definition of a movement structure.

FIG. 19 A diagram showing an example of the load in the case of lowering the definition of the movement structure.

FIG. 20 A diagram showing an example of glTF2.0.

FIG. 21 A diagram showing an example of glTF2.0.

FIG. 22 A diagram showing an example of glTF2.0.

FIG. 23 A diagram showing an example of an MP4 file.

FIG. 24 A diagram showing an example of MPD.

FIG. 25 A diagram showing an example of Universal Scene Description.

FIG. 26 A diagram showing an example of Universal Scene Description.

FIG. 27 A diagram showing an example of Universal Scene Description.

FIG. 28 A block diagram showing a main configuration example of a distribution device.

FIG. 29 A flowchart illustrating an example of a flow of distribution processing.

FIG. 30 A flowchart illustrating an example of a flow of generation processing.

FIG. 31 A block diagram showing a main configuration example of a reproduction device.

FIG. 32 A flowchart illustrating an example of a flow of reproduction processing.

FIG. 33 A flowchart illustrating an example of a flow of acquisition processing.

FIG. 34 A flowchart illustrating an example of a flow of the acquisition processing.

FIG. 35 A flowchart illustrating an example of a flow of the acquisition processing.

FIG. 36 A block diagram showing a main configuration example of a computer.

### MODES FOR CARRYING OUT THE INVENTION

Hereinafter, modes for carrying out the present disclosure (hereinafter, will be referred to as embodiments) will be described. It is noted that descriptions will be given in the following order.
1. Literatures that support technical contents and technical terms, etc.
2. Reproduction of Skinned model
3. Control of definition related to 3D model
4. First embodiment (distribution device)
5. Second embodiment (reproduction device)
6. Notes

### 1. Literatures that Support Technical Contents and Technical Terms, Etc.

The range disclosed in the present technology includes not only contents described in the embodiments but also contents described in the following patent literature, non-patent literature, and the like that have already been known at the time of the application, contents of other literatures that are referenced in the following patent literature and non-patent literature, and the like.
Patent Literature 1: (described above)
Non-Patent Literature 1: (described above)

In other words, the contents described in the literatures described above, the contents of other literatures that are referenced in the literatures described above, and the like also become grounds in determining supporting conditions.

### 2. Reproduction of Skinned Model

### <Skinned Model>

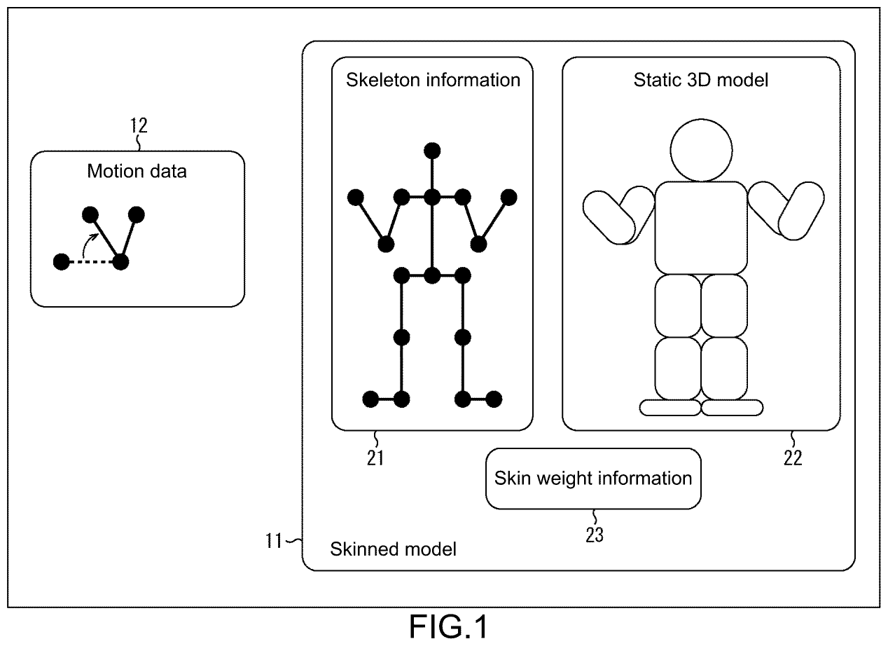

From the past, there has been a Skinned model as a 3D model that expresses a three-dimensional shape of an object. For example, as shown in FIG. 1, a Skinned model 11 includes skeleton information 21, a static 3D model 22, and skin weight information 23.

The skeleton information 21 is information that indicates a skeletal structure of the 3D model, which is called bones. In the skeleton information 21 shown in FIG. 1, the straight lines between black dots indicate bones. The joints between the bones (black dots in the skeleton information 21 in FIG. 1) are structured to be movable, and these joints express the joints of the 3D model. In other words, the skeleton information 21 can also be said to be information that indicates a pose of the 3D model based on the arrangement (movement) of the bones. In other words, since the bone structure determines how the 3D model can move, the skeleton information 21 can also be said to be information that indicates a movement structure of the 3D model.

The static 3D model 22 is, for example, information that expresses a three-dimensional structure of an object, such as a mesh or a point cloud. In other words, the static 3D model 22 can be said to be information indicating an appearance of the 3D model. By forming the static 3D model 22 in accordance with the shape (bone arrangement) of the skeleton information 21, it is possible to indicate the appearance of the pose indicated by the skeleton information 21.

The skin weight information 23 is information that associates (the bones of) the skeleton information 21 with (vertices and/or the like of) the static 3D model. In other words, the skin weight information 23 can also be said to be information that indicates a correspondence relationship between (the bones of) the skeleton information 21 and (the vertices and/or the like of) the static 3D model 22. According to the correspondence relationship indicated by this skin weight information 23, the shape of the static 3D model 22 can be made to correspond to the shape of the skeleton information 21. It is noted that as described above, the skeleton information indicates the movement structure of the 3D model, and the static 3D model 22 indicates the appearance of the 3D model, so the skin weight information 23 can also be said to be information that indicates the correspondence relationship between the appearance and the movement structure.

Such a Skinned model 11 can be moved by motion data 12. The motion data 12 is information that indicates how the Skinned model 11 moves. More specifically, the motion data 12 is constituted of information that indicates how each bone of the skeleton information 21 moves, and/or the like. Therefore, the motion data 12 can also be said to be information that indicates the movement of the 3D model.

Currently, development of a moving image distribution technology (6DoF video distribution technology) that provides a viewing experience from any viewpoint position is underway. In order to enable viewing from any position, everything that appears in moving image content is constituted of 3D objects such as meshes and/or point clouds, and the 3D objects are distributed together with a scene description file that manages scene information including where each of the 3D objects is to be arranged in a virtual space, so that users can move freely in the virtual space and view the content from any position they like. In particular, a technology that captures one's own movements as motion data and recreates those movements through an avatar existing in the virtual space, to perform not only one-way viewing but also two-way remote communication such as conversations, gestures, and cooperative activities with other users has been attracting attention in recent years.

In such experiential-type content, quality of a user experience in the virtual space is important. One of the values that constitutes the quality is reality. In other words, the closer the experience is to the experience in the real space, the less uncomfortable the user feels and the more naturally the user can accept the experience. In other words, the quality of a user experience is improved. Therefore, a more realistic experience (more accurate recreation of the experience in the real space) is required in the virtual space. For example, not only one-way viewing but also two-way remote communication such as conversations, gestures, and cooperative activities with other users is realized in the virtual space. In order to improve the reality in such a user experience, for example, improvements in quality of an avatar in terms of appearance (i.e., definition of appearance) and/or faithful recreation of movements of human beings (i.e., definition of movements and the like) are required. Ideally, realization of a true metaverse that enables a realistic virtual space recreation that is indistinguishable from the real space and natural interactions as if being in the same space as a person at a remote location is required.

By applying a bone animation that uses the Skinned model 11 described above as such an avatar, it is possible to express more realistic appearances and movements by, for example, projecting user's facial expressions, gestures, and lip movements in real time. However, the bone animation requires a large amount of information due to its structure, and thus a load of reproduction processing is large. Therefore, for example, since the number of bones largely affects the processing load of animation, it is sometimes recommended to limit the number of bones used for one object to around 30 in order to obtain optimal performance.

However, to make an avatar realistic as in the real space, a massive number of bones are required. For example, in order to express high realism, some avatars use as many as 713 bones just for the face. Such a large amount of data needs to be transmitted to all users existing in the space without any time lag and processed in real time (instantly). Even the slightest delay will impair the realism and cause users to feel a sense of discomfort. There are not enough resources, and some say that 1000 times the current computing resources will become necessary, to process everything in real time without impairing the realism in this manner. In this regard, it becomes very important to perform an optimal processing load adjustment for suppressing processing resources without impairing the realism that the user feels. In other words, a method of reducing a load of the reproduction processing has been required.

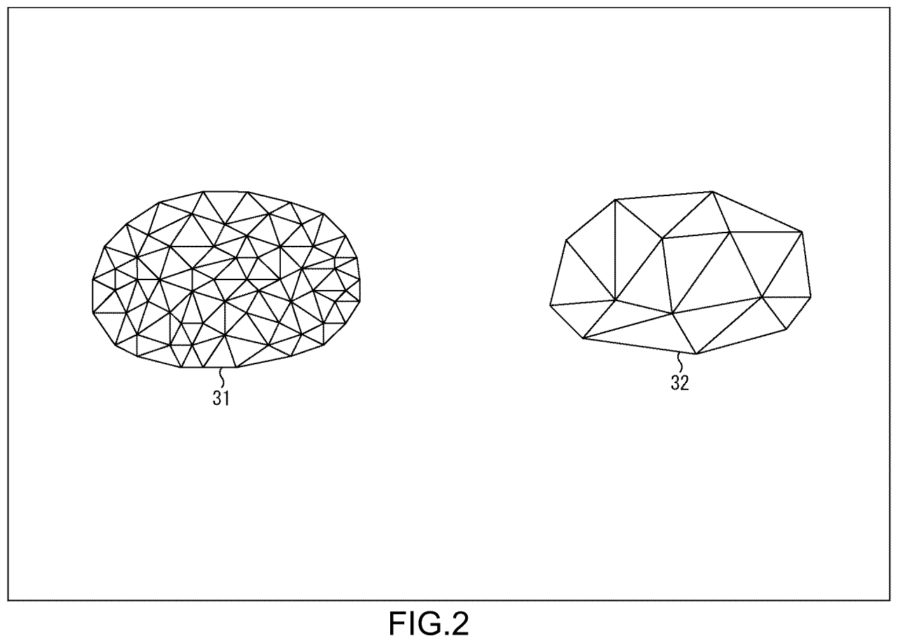

For example, Patent Literature 1 has proposed a method of reducing a load of the reproduction processing by lowering definitions of an appearance and movement structure of a 3D model in accordance with a distance from a viewpoint. That is, in 3D CG, a single 3D object has a plurality of pieces of model data (static 3D models and skeleton information) with different definitions, and the model data to be displayed is switched in accordance with a distance from a viewpoint of the user to the 3D object. For example, a static 3D model 31 and a static 3D model 32 shown in FIG. 2 are provided so that the more-detailed static 3D model 31 is displayed when the distance from the viewpoint is short, and the coarser static 3D model 32 is displayed when the distance from the viewpoint is long. The static 3D model 32 has fewer vertices and faces than the static 3D model 31, and therefore has a smaller amount of information. Therefore, by displaying the static 3D model 32, an increase in the load of the reproduction processing can be suppressed. By displaying a coarse static 3D model like the static 3D model 32 for an avatar located far from the viewpoint, it is possible to make it difficult for the user to notice the lowering of the definition of the appearance (the definition related to geometry of a model as typified by the number of polygons in a mesh or the number of vertices in a point cloud). In other words, the influence of the lowering of the definition of the appearance on the quality of a user experience is suppressed.

In the case of the method described in Patent Literature 1, control of a definition of the skeleton information (i.e., movement structure) is performed along with such control of the definition of the static 3D model (i.e., appearance). For example, when the distance from the viewpoint to the 3D model is short, skeleton information of a higher definition (i.e., skeleton information with a larger number of bones) is selected. Conversely, when the distance from the viewpoint to the 3D model is long, skeleton information of a lower definition (i.e., skeleton information with a smaller number of bones) is selected. In general, the larger the number of bones is, the more complex the movement that can be expressed becomes, but the load of the reproduction processing increases. Conversely, the smaller the number of bones is, the simpler the movement that can be expressed becomes, but the load of the reproduction processing decreases. By selecting low-definition skeleton information for an avatar located far from the viewpoint, it is possible to make it difficult for the user to notice the lowering of the definition of the movement structure (the number of bones). In other words, the influence of the lowering of the definition of the movement structure on the quality of a user experience is suppressed.

In this method, however, only control that is based on the distance from a viewpoint has been possible. For example, a high-definition static 3D model and high-definition skeleton information have been applied to a 3D model located close to a viewpoint. Therefore, in such a case where a 3D model is located close to a viewpoint, and/or the like, it has been difficult to reduce the load of the reproduction processing. For example, there has been a fear that, if the number of 3D models located close to a viewpoint increases, the load of the reproduction processing will increase. In addition, since the definitions of the static 3D model and the skeleton information are controlled based on a common parameter (distance), it has been necessary to lower the quality of the appearance in order to reduce the load of the reproduction processing. Therefore, there has been a fear that the quality of a user experience will be lowered. For example, if the load of the reproduction processing is to be reduced in the case where the number of 3D models located close to a viewpoint is increased as described above, it has been necessary to apply a low-definition static 3D model to the 3D models located close to the viewpoint. Therefore, there has been a fear that the quality of the appearance of the 3D models located close to the viewpoint will be lowered. In other words, there has been a fear that the quality of a user experience will be prominently lowered. Thus, this method has not always been the best.

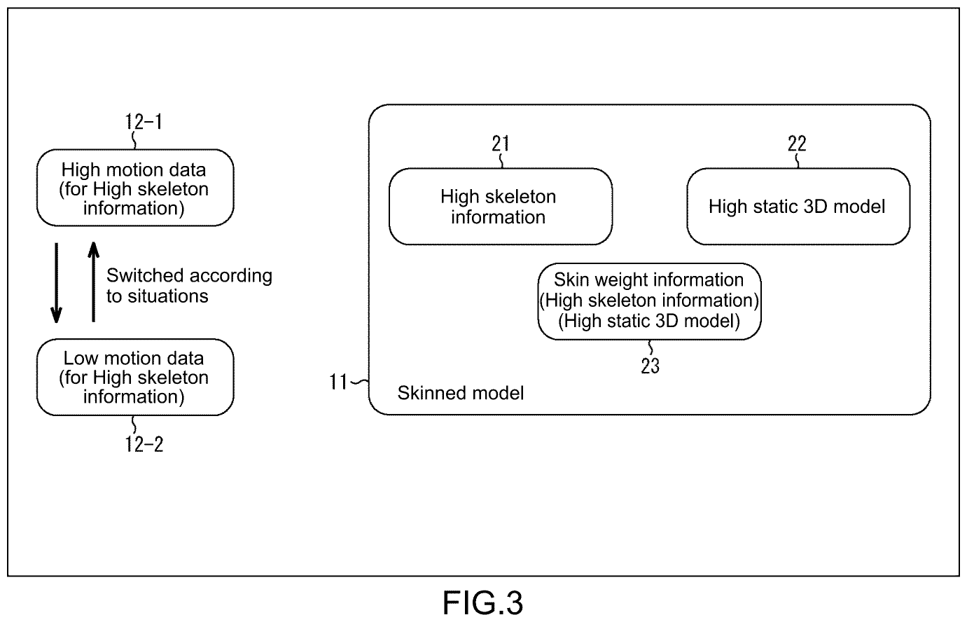

Further, Non-Patent Literature 1 has proposed a method of reducing the load of the reproduction processing by lowering a definition of motion data (a definition of a movement) for moving a Skinned model. In the case of this method, for example, as shown in FIG. 3, high-definition motion data (High motion data 12-1) and low-definition motion data (Low motion data 12-2) are prepared, and the motion data to be used is switched according to situations.

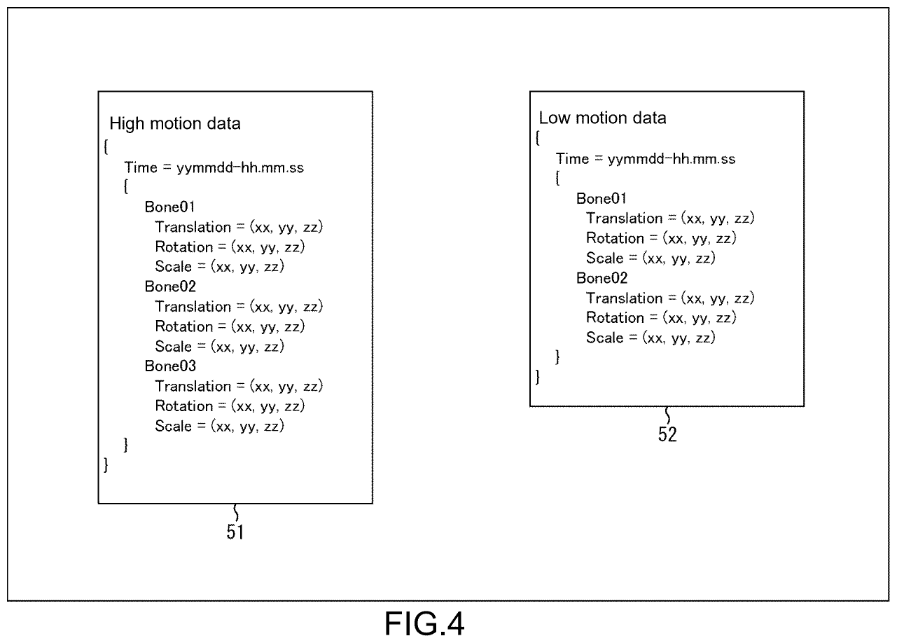

Description examples of the High motion data 12-1 and the Low motion data 12-2 are shown in FIG. 4. The description example 51 shows a description example of the High motion data 12-1. The description example 52 shows a description example of the Low motion data 12-2. The motion data is an aggregation of Transform information (Translation, Rotation, and Scale information) that expresses, based on a skeleton structure of a Skinned model to be animated, a movement of each bone constituting the skeleton. In the case of the description example 51, Transform information of three bones (Bone01, Bone02, and Bone03) is shown, and in the case of the description example 52, Transform information of two bones (Bone01 and Bone02) is shown. That is, in the description example 52, the description of the Transform information of Bone03 is omitted as compared to the description example 51, and thus the amount of information is reduced that much from that of the description example 51. Since the Transform information that is not shown in the motion data (bone movement (pose change)) is processed as no movement of the bone, it is possible to independently adjust an animation processing load.

In the present specification, bones connected on a terminal side out of the plurality of bones connected in series are referred to as a child bone, a grandchild bone, . . . (collectively referred to as descendant bones), and bones connected to the opposite side are referred to as a parent bone, a grandparent bone, . . . (collectively referred to as ancestor bones). In the motion data, a movement of a certain bone is indicated as a movement that uses its parent bone as a reference (relative movement). In other words, an actual movement of a certain bone is a movement obtained by combining movements of that bone and all of its ancestor bones that are described in the motion data. Therefore, for example, in the case of the Low motion data 12-2 (description example 52), Bone03 is fixed (does not move) with respect to Bone02, but moves (the global position moves) in a holistic view.

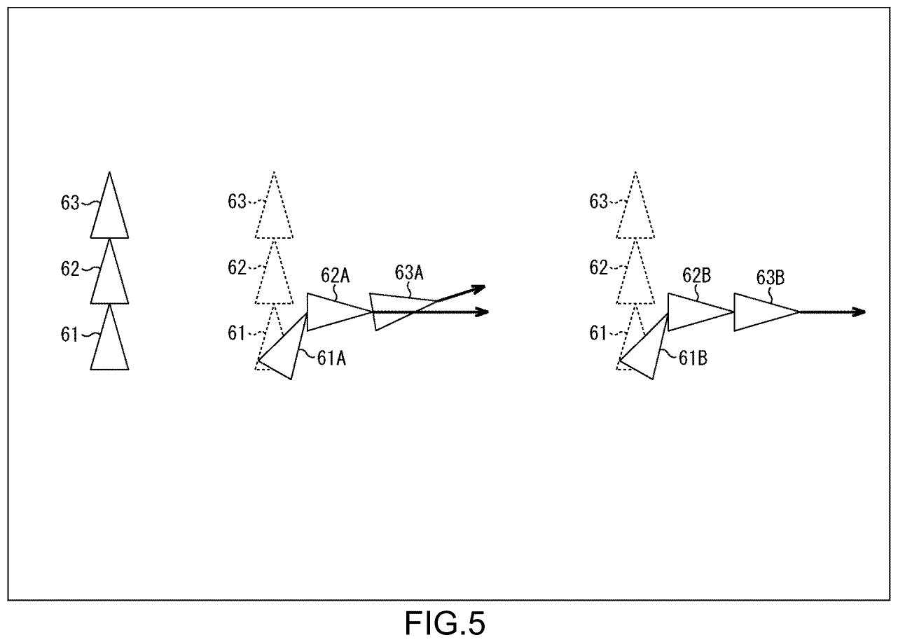

For example, it is assumed that, in an initial state, the position of Bone01 is a triangle 61 shown on the left side of FIG. 5, the position of Bone02 is a triangle 62 shown on the left side of FIG. 5, and the position of Bone03 is a triangle 63 shown on the left side of FIG. 5. In other words, it is assumed that Bone01 to Bone03 are connected in series in the same direction (straight line).

In the case of the High motion data 12-1 (description example 51), the movements of Bone01 to Bone03 are described, so that, for example, as shown in the center of FIG. 5, Bone01 to Bone03 can be moved in directions independent of one another. In the case of the example shown in the center of FIG. 5, Bone01 moves from the position of the triangle 61 to the position of the triangle 61A. Bone02 moves from the position of the triangle 62 to the position of the triangle 62A. Bone03 moves from the position of the triangle 63 to the position of the triangle 63A. As indicated by the arrows, after the movements, Bone02 (triangle 62A) and Bone03 (triangle 63A) face different directions.

In contrast, in the case of the Low motion data 12-2 (description example 52), the movements of only Bone01 and Bone02 are described, so that, for example, as shown on the right side of FIG. 5, a positional relationship (relative pose) between Bone02 and Bone03 remains fixed. In the case of the example shown on the right side of FIG. 5, Bone01 moves from the position of the triangle 61 to the position of the triangle 61B. Bone02 moves from the position of the triangle 62 to the position of the triangle 62B. Bone03 moves from the position of the triangle 63 to the position of the triangle 63B. As indicated by the arrow, after the movements, Bone02 (triangle 62B) and Bone03 (triangle 63B) face the same direction.

In other words, in the case of the Low motion data 12-2 (description example 52), a degree of freedom of the movement of Bone 03 is reduced as compared to the case of the High motion data 12-1 (description example 51). In other words, in the case of the Low motion data 12-2 (description example 52), the definition of the movement is lowered as compared to the case of the High motion data 12-1 (description example 51). Therefore, an amount of processing can be reduced for processing related to the movement in the reproduction processing.

For example, in the case of an avatar, the lowering of the definition of the motion data (i.e., the definition of the movement) as described above leads to an increase of the number of user movements that cannot be expressed by the avatar. For example, even if the user bends his/her finger, the movement may not be expressed in the motion data, and the movement may not be reflected on the movement of the avatar. However, a user on an avatar viewing side is unlikely to notice that the definition of the movement has been lowered since the user does not know whether or not the user of the avatar has bent his/her finger. In other words, it is possible to suppress an increase in the load of the reproduction processing while suppressing lowering of the quality of a user experience. In particular, unless the avatar is important to the user on the viewing side (e.g., unless the avatar is a conversation partner or the like), the sense of discomfort caused by the lowering of the definition of the movement (the number of movable parts is reduced, and movements are restricted) is even less likely to be caused.

Also in this method, only the definition of the motion data (i.e., the definition of the movement) is controlled, and the definition of the appearance is not changed. Therefore, even if this method is applied to an avatar located close to a viewpoint position, it is possible to suppress an increase in the load of the reproduction processing while suppressing lowering of the quality of a user experience.

In the case of this method, however, there has been a fear that, since only the amount of information of the motion data is reduced, and the amount of information of a Skinned model remains unchanged, and/or the like, the reduction in the load of the reproduction processing will be limited. In other words, also this method has not always been the best.

In view of the circumstances as described above, there has been a demand for another method for suppressing an increase in the load of reproduction processing while suppressing lowering of quality of a user experience.

### 3. Control of Definition Related to 3D Model

### <Method 1>

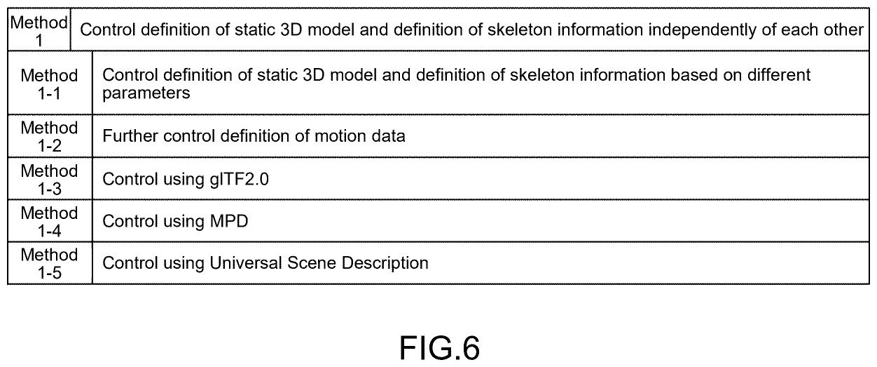

In this regard, as shown on the top row of the table shown in FIG. 6, the definition of the static 3D model and the definition of the skeleton information are controlled independently of each other (Method 1).

For example, a first information processing apparatus may include: a static 3D model definition setting unit which sets a definition of a static 3D model indicating an appearance of a 3D model; a skeleton information definition setting unit which sets, independently of the static 3D model, a definition of skeleton information indicating a movement structure of the 3D model; and a content reproduction unit which reproduces content including the static 3D model and the skeleton information that correspond to the set definitions and skin weight information indicating a correspondence relationship between the appearance and the movement structure.

For example, a first information processing method executed by the first information processing apparatus may include: setting a definition of a static 3D model indicating an appearance of a 3D model; setting, independently of the static 3D model, a definition of skeleton information indicating a movement structure of the 3D model; and reproducing content including the static 3D model and the skeleton information that correspond to the set definitions and skin weight information indicating a correspondence relationship between the appearance and the movement structure.

Here, the static 3D model may be any information as long as it indicates an appearance of a 3D model. For example, the static 3D model may be constituted of 3D data that expresses a three-dimensional structure of an object. For example, the static 3D model may be point cloud data that expresses a shape of an object by an aggregation (distribution) of points indicating the presence of an object in a small area. Alternatively, the static 3D model may be mesh data that expresses a surface shape of an object by vertices and connections (edges) between the vertices (and faces formed by them). Moreover, the static 3D model may include attribute information such as texture. Of course, the static 3D model may be 3D data other than these.

The definition of the static 3D model (i.e., the definition of the appearance) is variable. For example, the static 3D model may have variations in the definition of the appearance, and one of the variations may be applied. In other words, the static 3D model may be hierarchized according to the definition of the appearance. For example, static 3D models with a plurality of definitions as typified by a high-definition static 3D model and a low-definition static 3D model may be prepared as candidates, and a static 3D model with a desired definition may be selected and applied from among the candidates. In the present specification, this hierarchy will also be referred to as LoD (Level Of Detail). It is noted that the number of variations (number of LoDs) of the static 3D model may be any number as long as it is two or more. Of course, a static 3D model with a freely set definition may be generated and provided without preparing the variations (plurality of candidates).

In the static 3D model, the definition of the appearance may be expressed in any way. For example, when the static 3D model is point cloud data, the definition of the appearance may be expressed by the number of vertices. For example, the definition of the static 3D model may become higher as the number of points increases, and the definition of the static 3D model may become lower as the number of points decreases. Alternatively, when the static 3D model is mesh data, the definition of the appearance may be expressed by the number of vertices and/or the number of connections (or the number of faces). For example, the definition of the static 3D model may become higher as the number of faces increases, and the definition of the static 3D model may become lower as the number of faces decreases. Alternatively, the definition of the appearance may be expressed by a resolution of attribute information such as texture, and/or the like. Of course, the definition of the appearance may be expressed by information other than that of these examples.

Further, the skeleton information may be any information as long as it indicates a movement structure of a 3D model. For example, the skeleton information may indicate a movement structure of a 3D model by a bone group, or may indicate the movement structure of a 3D model by information other than bones.

The definition of the skeleton information (i.e., the definition of the movement structure) is variable. For example, the skeleton information may have variations in the definition of the movement structure, and one of the variations may be applied. In other words, the skeleton information may be hierarchized according to the definition of the movement structure. For example, the skeleton information of a plurality of definitions as typified by high-definition skeleton information and low-definition skeleton information may be prepared as candidates, and the skeleton information of a desired definition may be selected and applied from among the candidates. In the present specification, this hierarchy will also be referred to as LoD. It is noted that the number of variations (number of LoDs) of this skeleton information may be any number as long as it is two or more. Of course, skeleton information with a freely set definition may be generated and provided without preparing the variations (plurality of candidates).

In the skeleton information, the definition of the movement structure may be expressed in any way. For example, when the skeleton information is information that indicates the movement structure of a 3D model by a bone group, the definition of the movement structure may be expressed by the number of bones (number of joints (connections between bones)). For example, the definition of the skeleton information may become higher as the number of bones increases, and the definition of the skeleton information may become lower as the number of bones decreases. Of course, the definition of the movement structure may be expressed by information other than that of this example.

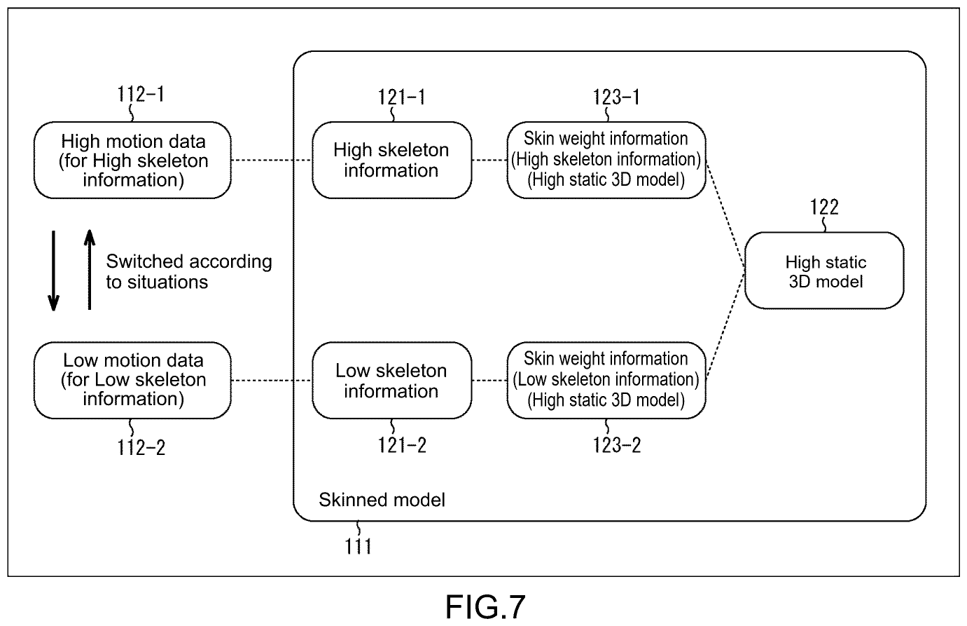

“Control independently of each other” in Method 1 means controlling one without depending on the other. For example, it means controlling the definition of the static 3D model without depending on the control of the definition of the skeleton information. It also means controlling the definition of the skeleton information without depending on the control of the definition of the static 3D model. Therefore, for example, as shown in FIG. 7, it is possible to perform control to change the definition of the skeleton information without changing the definition of the static 3D model.

In the case of the example shown in 7, in a Skinned model 111, while the definition of the static 3D model remains constant (remains as the High static 3D model 122), the definition of the skeleton information is switched (controlled) as in a case where high-definition High skeleton information 121-1 is applied or a case where low-definition Low skeleton information 121-2 is applied. By such control, for example, it is possible to lower the definition of the skeleton information without lowering the definition of the static 3D model.

By lowering the definition of the skeleton information (lowering the definition of the movement structure), an increase in the load of the reproduction processing can be suppressed. Also by lowering the definition of the static 3D model (lowering the definition of the appearance), an increase in the load of the reproduction processing can be suppressed, but in that case, there is a fear that the quality of the appearance will be lowered, and the quality of a user experience will thus be lowered. By lowering the definition of the skeleton information without lowering the definition of the static 3D model as in the example of FIG. 7, an increase in the load of the reproduction processing can be suppressed without lowering the definition of the appearance. In other words, an increase in the load of the reproduction processing can be suppressed while suppressing the lowering of the quality of a user experience.

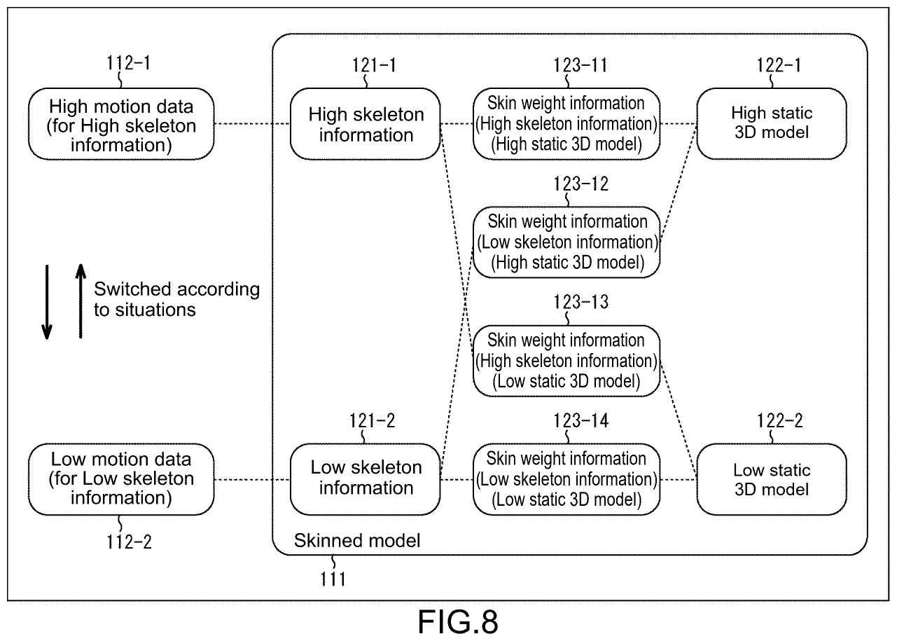

Of course, the definition of the static 3D model can also be controlled as in the example of FIG. 8. As described above, the control of the definition of the static 3D model can be performed independently of the control of the definition of the skeleton information. That is, in the example of FIG. 8, a switch between a high-definition High static 3D model 122-1 and a low-definition Low static 3D model 122-2 can be performed independently of a switch between the High skeleton information 121-1 and the Low skeleton information 121-2. Therefore, for example, the High skeleton information 121-1 and the High static 3D model 122-1 may be applied. Alternatively, the High skeleton information 121-1 and the Low static 3D model 122-2 may be applied. Alternatively, the Low skeleton information 121-2 and the High static 3D model 122-1 may be applied. Alternatively, the Low skeleton information 121-2 and the Low static 3D model 122-2 may be applied. In this manner, more diverse control can be performed. Therefore, more diverse control can be performed in the control of the load of the reproduction processing. Thus, it becomes possible to perform control that is more suited for the situation, and suppress an increase in the load of the reproduction processing while suppressing lowering of the quality of a user experience.

For example, by lowering the definition of the static 3D model for a 3D model in which the lowering of the quality of the appearance is not noticeable, such as a 3D model located far from a viewpoint position, an increase in the load of the reproduction processing can be further suppressed while suppressing the lowering of the quality of a user experience. In addition, by lowering the definition of the static 3D model without lowering the definition of the skeleton information for a 3D model that is located far from the viewpoint position to some extent but has an impressional and noticeable movement, the quality of the movement can be maintained while lowering the quality of the appearance. In other words, it is possible to perform control to lower the quality of less noticeable information and maintain the quality of more noticeable information. Therefore, in a wider variety of situations, an increase in the load of the reproduction processing can be further suppressed while further suppressing the lowering of the quality of a user experience.

### <Example of Variations of Definition of Movement Structure>

Next, an example of the variations of the definition of the movement structure, such as the High skeleton information 121-1 and the Low skeleton information 121-2 will be described. In order to recreate realistic movements, a current skeleton structure of a Skinned model (e.g., a bone structure of an avatar) has evolved into a complex high-definition structure with a deep hierarchical structure as described below.
Level 1: A skeleton structure constituted of bones for expressing movements of human bones and muscles, such as hands, legs, neck, fingers, mouth, and eyes
Level 2: A skeleton structure in which, in addition to the bones of Level 1, bones for recreating a movement of a swaying object such as clothing or hair that occurs due to a movement of the hands, legs, and/or neck are added to terminals
Level 3: A skeleton structure in which, in addition to Level 2, bones for recreating a minute change of a movement, such as wrinkles in a face or wrinkles of clothes are further added to the terminals

This is an evolution and an increase of the definition (Level 1→Level 2→Level 3) by addition of bones for recreating more detailed movements in pursuit of higher realism on the basis of the skeleton structure of Level 1 for recreating basic movements of human beings. Therefore, it can be considered as the addition of bones for recreating more minute movements as the level of the high definition increases, and also bones that are rather less likely to be noticed depending on a viewing situation. Further, conversely to the minuteness of the movement to be expressed, a larger number of bones needs to be added for expressing these minute movements. Therefore, the number of bones that is reduced by merely switching from the skeleton structure of Level 3 to the skeleton structure of Level 2 is large, resulting in a sufficient reduction in the processing load and a small influence on the realism felt by the user in a viewing situation.

Therefore, such levels may be used to realize the hierarchization of the movement structure. For example, a high-definition layer (H-LoD) may be set as the skeleton structure of Level 3, a medium-definition layer (M-LoD) may be set as the skeleton structure of Level 2, and a low-definition layer (L-LoD) may be set as the skeleton structure of Level 1.

It is noted that the number of layers of the definition of the movement structure may be any number. For example, there may be three layers as in this example, two layers as in the example of FIG. 7, or four or more layers.

Further, the variations of this skeleton structure data with different definitions may be generated in advance. Alternatively, variations of the skeleton structure of lower-order LODs may be generated in real time (instantly) by deleting terminal bones from the H-LOD skeleton before the start of streaming of motion data.

### <Control of Skin Weight Information>

As shown in the examples of FIGS. 7 and 8, the skin weight information is also controlled according to the control of the definition of the static 3D model and the definition of the skeleton information. This skin weight information may be any information as long as it indicates a correspondence relationship between the appearance and the movement structure. For example, when the static 3D model is point cloud data and the skeleton information is information constituted of a bone group, the skin weight information may be information that indicates a correspondence relationship between the points and the bones. Alternatively, when the static 3D model is mesh data and the skeleton information is information constituted of a bone group, the skin weight information may be information that indicates a correspondence relationship between faces (or vertices and/or connections) of the mesh and the bones.

That is, a content of the skin weight information depends on the static 3D model and the skeleton information. In other words, the content of the skin weight information depends on the definitions of the static 3D model and the skeleton information. In other words, when the static 3D model and the skeleton information are hierarchized according to the definitions thereof as described above, the content of the skin weight information also has variations, and one of the variations is applied. In other words, the skin weight information may also be hierarchized. However, this hierarchical structure depends on both the definition of the appearance and the definition of the movement structure.

As in the example of FIG. 7, when the static 3D model is fixed at the High static 3D model 122 and the skeleton information has the variations of the High skeleton information 121-1 and the Low skeleton information 121-2, the skin weight information has variations of skin weight information 123-1 whose content corresponds to the High skeleton information 121-1 and the High static 3D model 122, and skin weight information 123-2 whose content corresponds to the Low skeleton information 121-2 and the High static 3D model 122.

As in the example of FIG. 8, when the static 3D model has the variations of the High static 3D model 122-1 and the Low static 3D model 122-2 and the skeleton information has the variations of the High skeleton information 121-1 and the Low skeleton information 121-2, the skin weight information has variations of skin weight information 123-11 whose content corresponds to the High skeleton information 121-1 and the High static 3D model 122-1, skin weight information 123-12 whose content corresponds to the Low skeleton information 121-2 and the High static 3D model 122-1, skin weight information 123-13 whose content corresponds to the High skeleton information 121-1 and the Low static 3D model 122-2, and skin weight information 123-14 whose content corresponds to the Low skeleton information 121-2 and the Low static 3D model 122-2.

Then, one of these variations having a content corresponding to the selection of the definitions of the static 3D model and the skeleton information is selected. It is noted that the number of variations (number of LoDs) of this skin weight information depends on the number of variations (number of LoDs) of each of the static 3D model and the skeleton information. Of course, it is also possible to generate and provide the skin weight information whose content corresponds to the selection of the definitions of the static 3D model and the skeleton information without preparing candidates (variations).

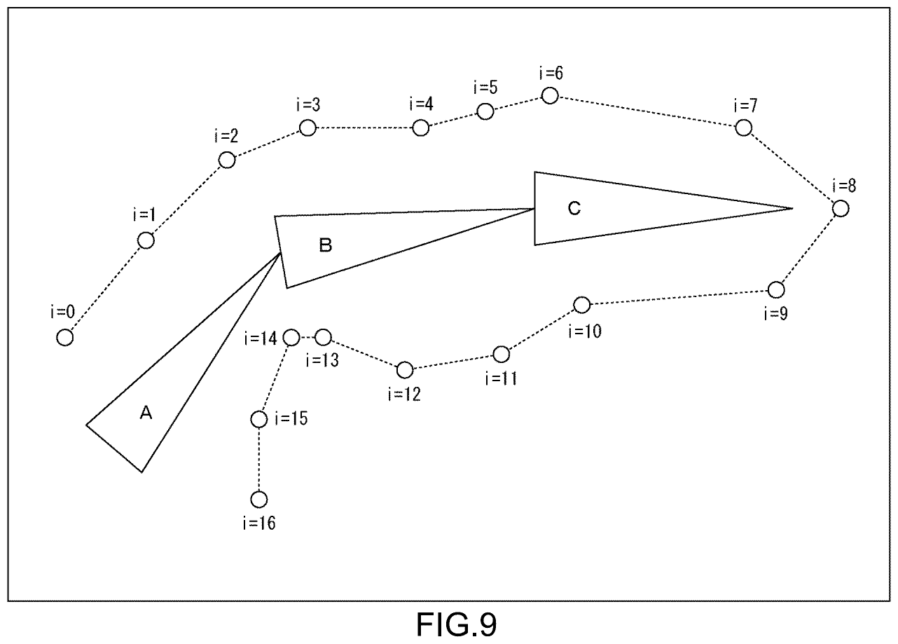

For example, it is assumed that, as shown in FIG. 9, a bone A, a bone B, and a bone C are described in the High skeleton information 121-1, and vertices i (i=0 to i=16) corresponding to those bones are described in the High static 3D model 122. It is noted that herein, descriptions will be given assuming that the static 3D model is mesh data.

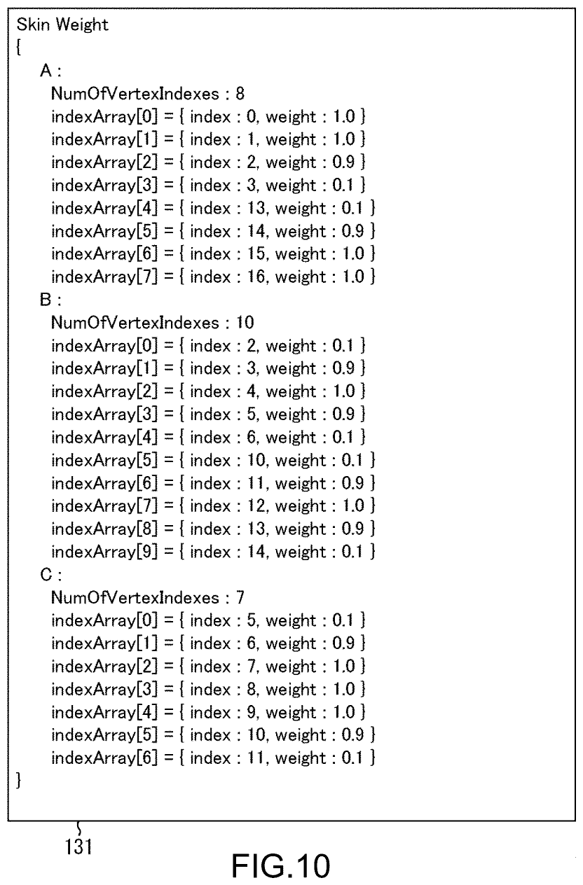

The description example 131 shown in FIG. 10 shows a description example of the skin weight information 123-1 in this case. As shown in FIG. 10, in the skin weight information, an index (index) and weight value (weight) of a vertex corresponding to a bone are described for each bone. The weight value indicates a magnitude of an influence of the vertex on the movement of the bone in a range of 0 to 1.0. In other words, the extent to which each vertex is influenced to move by the movement of the bone is indicated by this index and weight value. For example, when a position of a certain vertex P depends on the movements of the bone A and the bone B, the index and weight value of the vertex P are linked to each of the bone A and the bone B. The weight value linked to the bone A and the weight value linked to the bone B become 1.0 when added. When more strongly influenced by the movement of the bone A, the weight value on the bone A side is increased, and the weight value on the bone B side is decreased. Conversely, when more strongly influenced by the movement of the bone B, the weight value on the bone A side is decreased, and the weight value on the bone B side is increased.

In the case of the skin weight information 123-1, as shown in the description example 131, which vertex i corresponds to what bone out of the bones A to C and the weight value thereof are shown as a list of vertices. For example, the vertices (i=0, 1, 15, 16) correspond to only the bone A, and the weight values thereof are 1.0. The vertices (i=2, 14) correspond to the bone A and the bone B, and the weight values thereof are 0.9 and 0.1. The vertices (i=3, 13) correspond to the bone A and the bone B, and the weight values thereof are 0.1 and 0.9. Further, the vertices (i=4, 12) correspond to only the bone B, and the weight values thereof are 1.0. The vertices (i=5, 11) correspond to the bone B and the bone C, and the weight values thereof are 0.9 and 0.1. The vertices (i=6, 10) correspond to the bone B and the bone C, and the weight values thereof are 0.1 and 0.9. Moreover, the vertices (i=7, 8, 9) correspond to only the bone C, and the weight values thereof are 1.0.

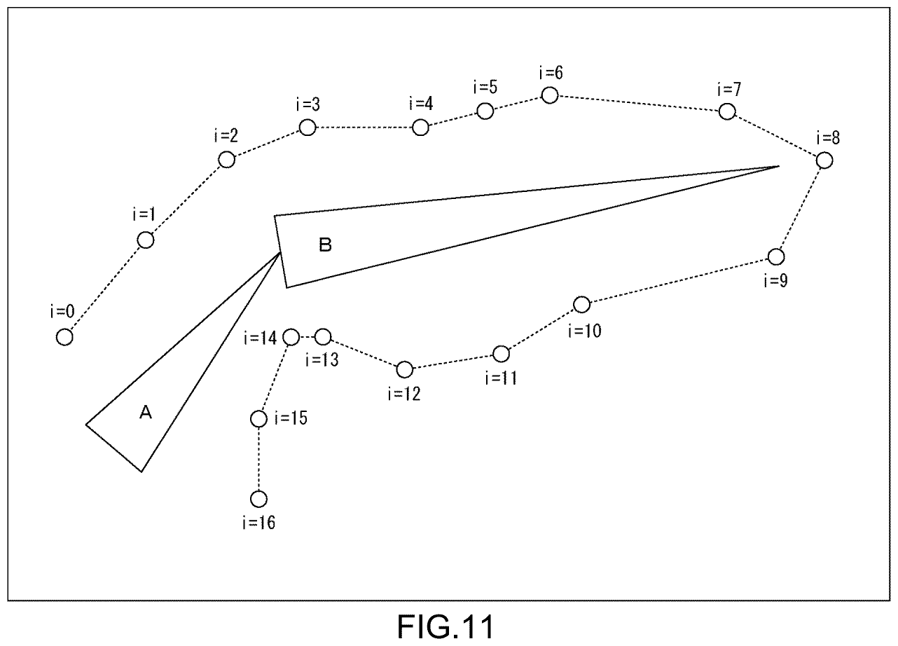

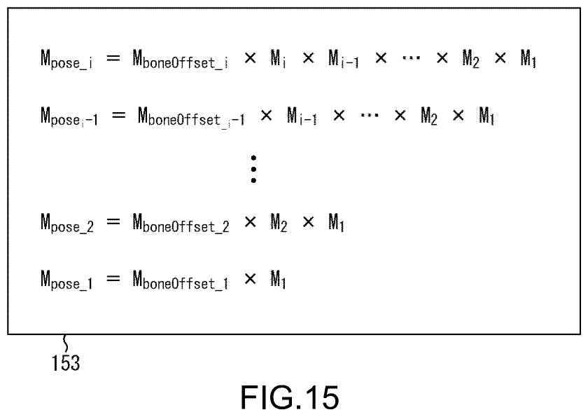

In contrast, as in the example shown in FIG. 11, in the Low skeleton information 121-2, the bone C is omitted, and the bone A and the bone B (which replace the bone B and the bone C in the example of FIG. 15) are described.

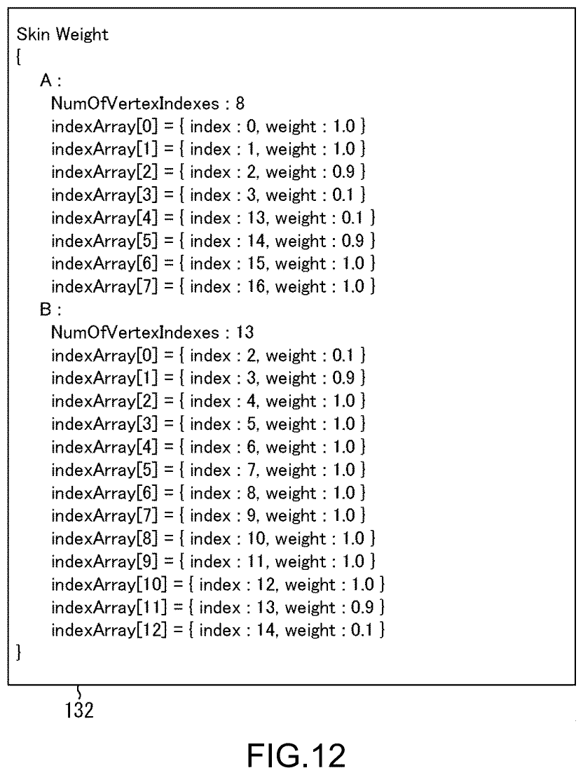

The description example 132 shown in FIG. 12 shows a description example of the skin weight information 123-2 in this case. In the case of the skin weight information 123-2, as shown in this description example 132, which vertex i corresponds to what bone out of the bone A and the bone B and the weight value thereof are shown as a list of vertices. In other words, each of the vertices that have been allocated to the bone A to the bone C in the description example 131 (FIG. 10) is reallocated to either the bone A or the bone B. For example, the vertices (i=0, 1, 15, 16) correspond to only the bone A, and the weight values thereof are 1.0. The vertices (i=2, 14) correspond to the bone A and the bone B, and the weight values thereof are 0.9 and 0.1. The vertices (i=3, 13) correspond to the bone A and the bone B, and the weight values thereof are 0.1 and 0.9. Further, the vertices (i=4, 5, 6, 7, 8, 9, 10, 11, 12) correspond to only the bone B, and the weight values thereof are 1.0. In other words, the correspondence relationship between bones and vertices is updated. At that time, the weight values are also updated as necessary.

From such variations, as described above, information corresponding to the control of the definition of the static 3D model and the definition of the skeleton information is selected. For example, in FIG. 7, when the High skeleton information 121-1 is applied, the skin weight information 123-1 is applied. When the Low skeleton information 121-2 is applied, the skin weight information 123-2 is applied. Further, in FIG. 8, when the High skeleton information 121-1 and the High static 3D model 122-1 are applied, the skin weight information 123-11 is applied. When the Low skeleton information 121-2 and the High static 3D model 122-1 are applied, the skin weight information 123-12 is applied. When the High skeleton information 121-1 and the Low static 3D model 122-2 are applied, the skin weight information 123-13 is applied. When the Low skeleton information 121-2 and the Low static 3D model 122-2 are applied, the skin weight information 123-14 is applied.

With such a configuration, the skin weight information can accurately indicate the correspondence relationship between the appearance and the movement structure, regardless of the definitions applied to the static 3D model and the skeleton information. If the correspondence relationship between the appearance and the movement structure, that is indicated by the skin weight information, is inaccurate, there is a fear that the quality of the 3D model will be lowered due to a three-dimensional shape losing its shape or a movement becoming unnatural in a reconstruction of a 3D model, and/or the like. Therefore, there is a fear that subjective quality of a display image (rendered image) will also be lowered, to thus lower the quality of a user experience. In particular, when the definition of the static 3D model and the definition of the skeleton information are controlled independently of each other, the correspondence relationship between the appearance and the movement structure becomes diverse more prominently, so a content of the skin weight information is likely to become inaccurate. Therefore, the quality of the 3D model is more likely to be lowered, and the quality of a user experience is more likely to be lowered. Therefore, as described above, by suppressing the lowering of the quality of the skin weight information and more accurately indicating the correspondence relationship between the appearance and the movement structure, it is possible to suppress the lowering of the quality of the 3D model, suppress the lowering of the subjective quality of a display image (rendered image), and suppress the lowering of the quality of a user experience. In other words, by controlling the content of the skin weight information along with the control of the definitions of the static 3D model and the skeleton information, it is possible to suppress an increase in the load of the reproduction processing while suppressing lowering of the quality of a user experience.

### <Method 1-1>

When Method 1 described above is applied, as shown on the second row from the top of the table shown in FIG. 6, the definition of the static 3D model and the definition of the skeleton information may be controlled based on different parameters (Method 1-1). In other words, in order to control the definition of the static 3D model and the definition of the skeleton information independently of each other, the control may be performed based on different parameters.

For example, in the first information processing apparatus described above, the static 3D model definition setting unit may set the definition of the static 3D model based on a first parameter, and the skeleton information definition setting unit may set the definition of the skeleton information based on a second parameter different from the first parameter.

By performing control based on the parameters that are independent of each other in this manner, the definition of the static 3D model and the definition of the skeleton information can be controlled independently of each other.

For example, the second parameter may be a parameter of a type different from that of the first parameter. That is, the definition of the static 3D model and the definition of the skeleton information may be controlled based on the parameters of different types.

For example, the first parameter may be a parameter related to a distance from a viewpoint position to the 3D model, and the second parameter may be a parameter related to the content, that is different from the distance. That is, the definition of the static 3D model may be controlled based on the parameter related to the distance from the viewpoint position (a position of a 3D model corresponding to a viewpoint user) to the 3D model to be processed. In addition, the definition of the skeleton information may be controlled based on the parameter related to the content including the 3D model and/or the like.

The parameter related to the distance may be any information as long as it is related to the distance from the viewpoint position to the 3D model. For example, the parameter may directly or indirectly indicate the distance (absolute value) from the viewpoint position to the 3D model. The parameter may further indicate a direction. Alternatively, the parameter may indicate a distance from the viewpoint position to a specific part of the 3D model. Alternatively, the parameter may indicate a change in the distance from the viewpoint position to the 3D model. Alternatively, the parameter may indicate a statistical value (e.g., an average value, a central value, or the like) related to the distance from the viewpoint position to the 3D model. Of course, the parameter related to the distance may indicate information other than that of these examples. Moreover, a plurality of parameters may be applied as this parameter related to the distance.

The parameter related to the content may be any information as long as it is related to the content. For example, the parameter may indicate a type of scene or an importance of the scene. Alternatively, the parameter may indicate a type of 3D model or an importance of the 3D model. Alternatively, the parameter may indicate a position of the 3D model or an orientation of the 3D model. Alternatively, the parameter may indicate a shape of the 3D model, a size of the 3D model, a color and/or pattern of the 3D model, and/or the like. Alternatively, the parameter may indicate what the 3D model is doing (how it moves), and/or the like. Alternatively, the parameter may indicate the number of 3D models to be reproduced at the same time, a degree of overlap of the 3D models in a display image, and/or the like. Alternatively, the parameter may indicate a current relationship with a viewpoint user or a past relationship with the viewpoint user. Alternatively, the parameter may be a statistical value (e.g., the average value, the central value, or the like) of some kind of information including the examples described above, for example. Of course, the parameter related to the content may indicate information other than that of these examples. Moreover, a plurality of parameters may be applied as this parameter related to the content.

In this manner, by controlling the definition of the skeleton information based on the parameter related to the content, it is possible to perform control of the definition of the skeleton information, that corresponds to a situation of the content, without depending on the distance from the viewpoint position. For example, in a scene where the lowering of the definition of the movement structure is less noticeable, the definition of the skeleton information of the 3D model can be lowered. In general, when the definition of the movement structure is lowered, the definition of the movement of the 3D model is also lowered. Therefore, there is a fear that, by lowering the definition of the movement structure, the movement of the 3D model will become unnatural (realism will be impaired), thus leading to lowering of the quality of a user experience depending on circumstances. However, as described above, by switching the definition of the skeleton information in accordance with a situation of the content, it is possible to make such unnaturalness of the movement of the object as inconspicuous as possible. For example, it is possible to reduce the definition of the skeleton information of a 3D model in a situation where the lowering of the definition of the movement structure is less noticeable, such as a 3D model with little movement, a 3D model at a position that is difficult to be seen from the viewpoint user, or a 3D model having little relationship with the viewpoint user. By such control, for example, the definition of the skeleton information can be lowered even for a 3D model located close to the viewpoint position. In addition, at this time, since the skeleton information is controlled independently of the static 3D model, it is possible to suppress an increase in the load of the reproduction processing while suppressing lowering of the quality of a user experience.

For example, when the Skinned model is an avatar, the definition of the movement structure (LoD of skeleton information) may be controlled based on whether or not the avatar is a current interaction partner for the viewpoint user. For example, in the case of an avatar that is the current interaction partner for the viewpoint user, it is assumed that the attention level of the viewpoint user with respect to the avatar is high. Therefore, if the definition of the movement structure of such an avatar is lowered, lowering of realism of the avatar becomes noticeable, and the viewpoint user is likely to feel a sense of discomfort. In other words, it is assumed that the quality of a user experience will highly likely be lowered. Therefore, the definition of the movement structure is increased for the avatar that is the current interaction partner for the viewpoint user, and the definition of the movement structure is decreased for avatars that are not. By such control, it is possible to suppress an increase in the load of the reproduction processing while suppressing lowering of the quality of a user experience.

Alternatively, the definition of the movement structure (LoD of skeleton information) may be controlled based on whether or not the avatar is a partner who has had a relationship with the viewpoint user in the past (e.g., within a predetermined time). For example, in the case of an avatar who has had a relationship with the viewpoint user in the past, it is assumed that the attention level of the viewpoint user with respect to the avatar remains high. Therefore, if the definition of the movement structure of such an avatar is lowered, lowering of realism of the avatar becomes noticeable, and the viewpoint user is likely to feel a sense of discomfort. In other words, it is assumed that the quality of a user experience will highly likely be lowered. Therefore, the definition of the movement structure is increased for the avatar which is the partner who has had a relationship with the viewpoint user in the past, and the definition of the movement structure is decreased for avatars who have not. By such control, it is possible to suppress an increase in the load of the reproduction processing while suppressing lowering of the quality of a user experience.

Further, the first parameter may be a parameter related to the distance from the viewpoint position to the 3D model, and the second parameter may be a parameter related to a load of the content reproduction processing. That is, the definition of the static 3D model may be controlled based on the parameter related to the distance from the viewpoint position (the position of the 3D model corresponding to the viewpoint user) to the 3D model to be processed. In addition, the definition of the skeleton information may be controlled based on the parameter related to the load of the reproduction processing.

The parameter related to the load of the reproduction processing may be any information as long as it is related to the load of the reproduction processing. For example, the parameter may directly or indirectly indicate the load of the reproduction processing. Alternatively, the parameter may indicate a current load of the reproduction processing, a past load of the reproduction processing, or a future load (i.e., prediction value) of the reproduction processing. Alternatively, the parameter may be a statistical value (e.g., an average value, a central value, or the like) related to the load of the reproduction processing. Of course, the parameter related to the load of the reproduction processing may indicate information other than that of these examples. In addition, a plurality of parameters may be applied as this parameter related to the load of the reproduction processing.

In this manner, by controlling the definition of the skeleton information based on the parameter related to the load of the reproduction processing, it is possible to perform control of the definition of the skeleton information, that corresponds to a condition of the load of the reproduction processing, without depending on the distance from the viewpoint position. For example, when the load of the reproduction processing increases and a delay is likely to occur, the definition of the skeleton information of the 3D model can be lowered as an emergency measure. If a delay occurs in the reproduction processing, for example, there is a fear that a display image (moving image) will be stopped or a frame will be lost, to prominently lower the quality of a user experience. Since an increase in the load of the reproduction processing can be suppressed by lowering the definition of the movement structure of the 3D model, an occurrence of such a situation can be suppressed. Compared to the delay in the reproduction processing, lowering of the definition of the movement structure of the 3D model results in less lowering of the quality of a user experience in general. In other words, by controlling the definition of the skeleton information based on the parameter related to the load of the reproduction processing, it is possible to suppress an increase in the load of the reproduction processing while suppressing the lowering of the quality of a user experience. It is noted that by controlling the definition of the skeleton information based on the parameter related to the load of the reproduction processing, the definition of the skeleton information can be lowered even for a 3D model located close to the viewpoint position, and thus an increase in the load of the reproduction processing can be suppressed. In addition, since the skeleton information is controlled independently of the static 3D model, lowering of the quality of a user experience can be suppressed by suppressing the lowering of the definition of the static 3D model.

Further, the definition of the skeleton information may be controlled adaptively with respect to the load of the reproduction processing. For example, the definition of the movement structure may become lower as the current load of the reproduction processing of content including a Skinned model increases (a margin of the load with respect to resources becomes smaller). Further, the definition of the movement structure may become higher as the current load of the reproduction processing decreases (the margin of the load with respect to resources becomes larger). Alternatively, both may be performed. For example, a range of a magnitude of the load (a magnitude of a margin of resources) may be determined in advance with respect to each layer of the definition of the movement structure, and a layer corresponding to the magnitude of the current load may be set as the definition of the movement structure. Alternatively, it is also possible to enable the layer of the definition of the movement structure to be applied to be derived from the magnitude of the load (the magnitude of the margin of resources) by a predetermined calculation.

Further, the second parameter may be a parameter having a value different from that of the first parameter. That is, the definition of the static 3D model and the definition of the skeleton information may be controlled based on the parameters having different values. That is, even if the first parameter and the second parameter are the same type of parameters, the first parameter and the second parameter only need to be parameters that may take different values. For example, the definition of the static 3D model and the definition of the skeleton information may be controlled based on parameters related to distances from the viewpoint position to different parts of the 3D model. Alternatively, one of the definitions may be controlled based on an absolute value of the distance from the viewpoint position to the 3D model, and the other one of the definitions may be controlled based on a signed distance from the viewpoint position to the 3D model. Alternatively, quantization units of the distance may differ. Alternatively, one of the definitions may be controlled based on a parameter that directly indicates the distance from the viewpoint position to the 3D model, and the other one of the definitions may be controlled by a parameter that indirectly indicates the distance from the viewpoint position to the 3D model. In this manner, also when performing the control based on the parameters having different values, the definition of the static 3D model and the definition of the skeleton information can be controlled independently of each other. It is noted that this parameter may be any information, and may of course be information other than the distances described above.

Alternatively, the second parameter may be a parameter of a timing different from that of the first parameter. That is, the definition of the static 3D model and the definition of the skeleton information may be controlled based on the parameters of different timings. That is, even if the first parameter and the second parameter are the same type of parameters, the acquisition timings only need to differ. For example, both the definition of the static 3D model and the definition of the skeleton information may be controlled based on the parameter related to the distance from the viewpoint position to the 3D model at different timings. “Different timings” refers to the timings at which the parameters are acquired (e.g., the timing at which the distance is measured). Of course, the timing at which the control is performed may also differ. For example, the distance from the viewpoint position to the 3D model may be measured at each of timings A, B, C, and D so that, at the timings A and C, the definition of the static 3D model is controlled based on the distances measured at those timings, and at the timings B and D, the definition of the skeleton information is controlled based on the distances measured at those timings. Alternatively, for example, the definition of the static 3D model may be controlled based on the current distance, and the definition of the skeleton information may be controlled based on the past distance. In this manner, also when performing the control based on the parameters of different timings, the definition of the static 3D model and the definition of the skeleton information can be controlled independently of each other. It is noted that this parameter may be any information, and may of course be information other than the distances described above.

### <Load of Reproduction Processing>

Next, descriptions will be given on the influence of the control of the definition of the static 3D model (the definition of the appearance) and the definition of the skeleton information (the definition of the movement structure) on the load of the reproduction processing. First, the load of the reproduction processing will be described. In animation processing, two types of processing, that is, “skeleton pose transformation processing” and “skinning processing”, are performed in this order.

The skeleton pose transformation processing is processing of calculating a 4×4 pose transformation matrix that expresses a current pose of each bone. In other words, this processing (calculation) is performed for the number of bones. The skinning processing is processing of moving each vertex of a mesh by performing a matrix calculation of each vertex and the pose transformation matrix of the bone to which the vertex is linked. In other words, this processing (calculation) is executed for the number of vertices.

Therefore, a magnitude of the load of the skinning processing depends on the number of vertices of the mesh, and does not depend on the number of bones of the skeleton. In contrast, the magnitude of the load of the skeleton pose transformation processing depends on the definition of the movement structure (the number of bones).

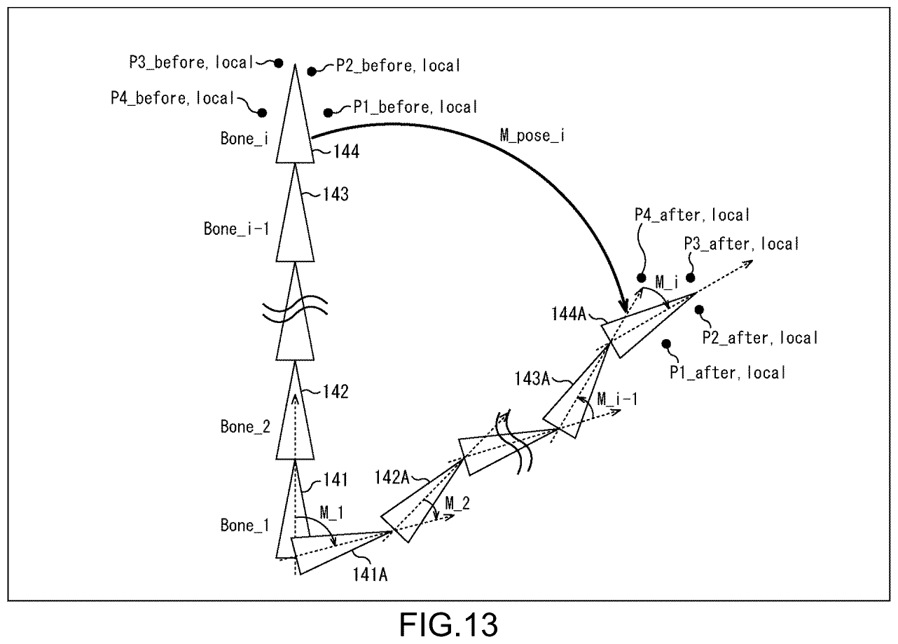

For example, as shown in FIG. 13, the initial pose of Bone_1 is assumed to be the pose 141. The initial pose of Bone_2 is assumed to be the pose 142. The initial pose of Bone_(i−1) is assumed to be the pose 143. The initial pose of Bone_i is assumed to be the pose 144. In other words, Bone_1 to Bone_i are assumed to be connected in series while facing the same direction in the initial poses. Further, it is assumed that vertices P1 to P4 of the mesh are associated with Bone_i by the skin weight information. It is assumed that the initial position of the vertex P1 is P1_(before, local), the initial position of the vertex P2 is P2_(before, local), the initial position of the vertex P3 is P3_(before, local), and the initial position of the vertex P4 is P4_(before, local).

It is assumed that the poses of Bone_1 to Bone_i are changed by the animation processing as shown in the example of FIG. 13. That is, the pose of Bone_1 is changed from the pose 141 to the pose 141A. The pose of Bone_2 is changed from the pose 142 to the pose 142A. The pose of Bone_(i−1) is changed from the pose 143 to the pose 143A. The pose of Bone_i is changed from the pose 144 to the pose 144A.

At this time, the motion matrix (pose transformation matrix) indicating the movement (pose change) of Bone_1 is M_1. The motion matrix indicating the movement of Bone_2 is M_2. The motion matrix indicating the movement of Bone_(i−1) is M_(i−1). The motion matrix indicating the movement of Bone_i is M_i. These motion matrices M_(M_1 to M_i) each indicate the pose change of the corresponding bone while using the pose of the parent bone as a reference. Therefore, since Bone_1 is a root bone with no parent bone, M_1 indicates a difference between the pose 141 and the pose 141A, while M_2 indicates a difference between the pose 141A and the pose 142A. Similarly, M_(i−1) indicates a difference between the pose of Bone_(i−2) after the movement and the pose 143A. M_i indicates a difference between the pose 144A and the pose 143A.

### <Load of Skeleton Pose Transformation Processing>

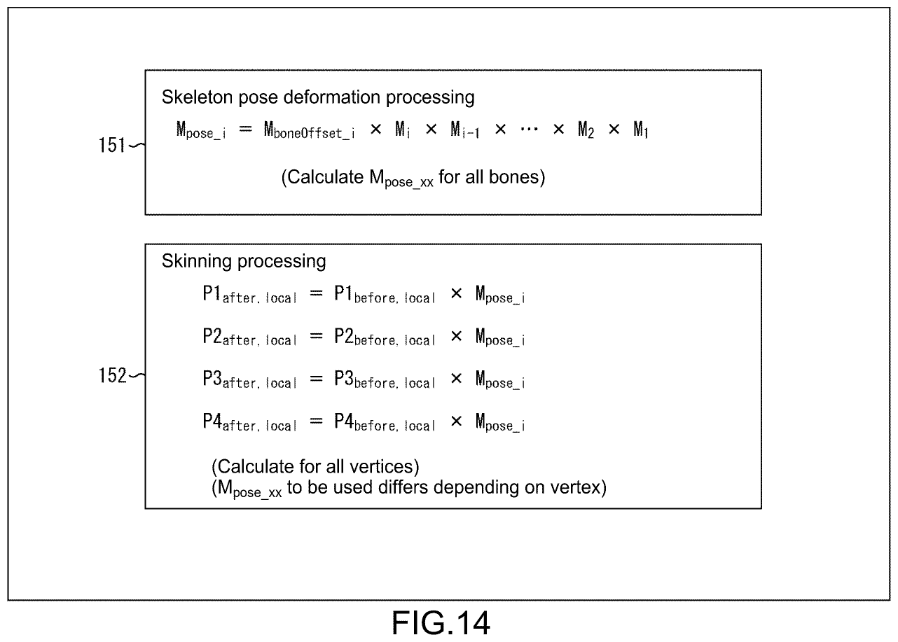

As shown in the square 151 in FIG. 14, the skeleton pose transformation processing for Bone_1 to Bone_i in FIG. 13 can be expressed by Expression (1) below. It is noted that in the square 151, letters with “_” may be expressed as subscripts.

M_(pose_i)=M_(boneOffset_i)×M_i×M_(i−1)× . . . ×M_2×M_1 (1)

It is noted that in Expression (1), M_(pose_i) is a motion matrix indicating the movement of Bone_i by this animation processing, that is, the difference between the pose 144 and the pose 144A. M_(boneOffset_i) is a bone offset matrix of Bone_i. In other words, M_(boneOffset_i) indicates the inverse matrix of the initial pose matrix of Bone_i. As shown in FIG. 13, the pose of Bone_i also changes by the movements of the ancestor bones. Therefore, as shown in Expression (1), the derivation of M_(pose_i) needs to reflect not only the motion matrix of that bone (Bone_i) but also the motion matrices of all the ancestor bones (root bone to parent bone).

Such skeleton pose transformation processing (the calculation of Expression (1)) is executed for each bone of Bone_1 to Bone_i. These calculations become a load of the skeleton pose transformation processing.

### <Load of Skinning Processing>

As shown in the square 152 in FIG. 14, the skinning processing for the vertices P1 to P4 in FIG. 13 can be expressed by Expressions (2) to (5) below. It is noted that in the square 152, letters with “_” may be expressed as subscripts.

P1(after,local)=P1_(before,local)×M_(pose_i) (2)

P2(after,local)=P2_(before,local)×M_(pose_i) (3)

P3(after,local)=P3_(before,local)×M_(pose_i) (4)

P4(after,local)=P4_(before,local)×M_(pose_i) (5)

In Expressions (2) to (5), P1_(after, local) indicates the position of the vertex P1 after the pose change (after the movement by the animation processing). P2_(after, local) indicates the position of the vertex P2 after the pose change (after the movement by the animation processing). P3_(after, local) indicates the position of the vertex P3 after the pose change (after the movement by the animation processing). P4_(after, local) indicates the position of the vertex P4 after the pose change (after the movement by the animation processing). It is noted that although M_(pose_i) is applied as the motion matrix in Expressions (2) to (5), the motion matrix of the bone to which the vertex to be processed corresponds is applied to this motion matrix. As in Expressions (2) to (5), the calculation for deriving the position of the vertex after the movement is performed for each vertex. These calculations become the load of the skinning processing.

### <Comparison of Loads>

It is assumed that the animation processing of FIG. 13 is performed with the definition of the movement structure (and movement) being the highest definition. In that case, the calculation (Expression (1)) for the skeleton pose transformation processing described above is executed for all bones (Bone_1 to Bone_i). In other words, the calculations shown in the square 153 in FIG. 15 are executed.

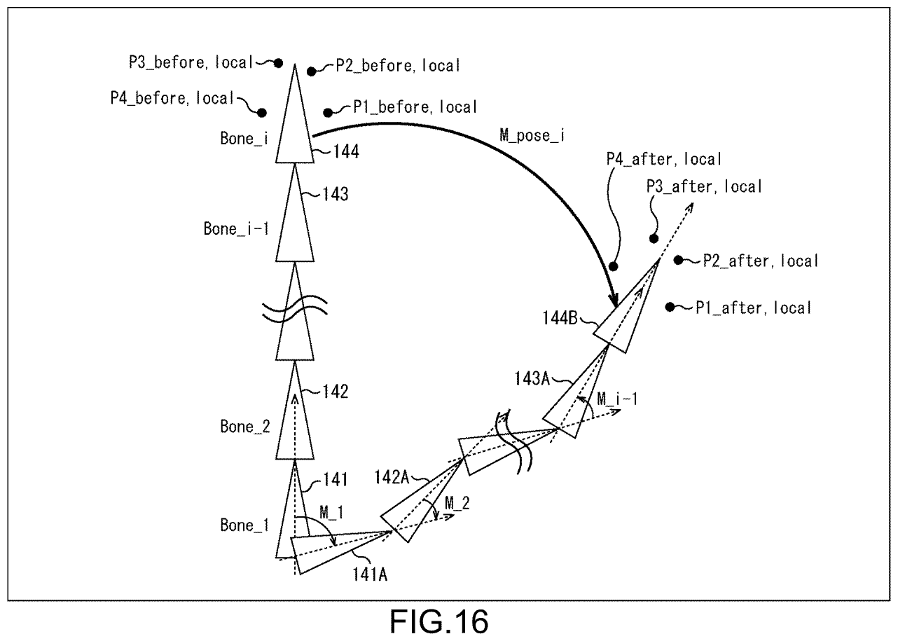

In contrast, it is assumed that the animation processing of FIG. 13 is performed while the definition of the movement is lowered as in the method described in Non-Patent Literature 1. For example, it is assumed that the movement (M_i) of Bone_i is omitted in the motion data. In that case, as shown in FIG. 16, Bone_i changes from the pose 144 to the pose 144B by this animation processing. In other words, the orientation of Bone_i after the movement becomes the same as that of Bone_(i−1).

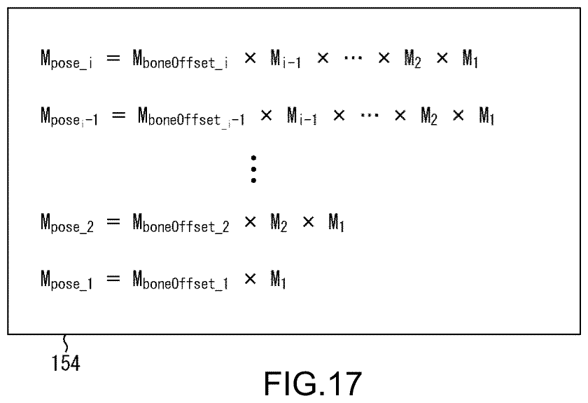

Therefore, in the calculation of the skeleton pose transformation processing, the motion matrix M_i can be omitted in the calculation to derive M_(pose_i), as shown in the square 154 in FIG. 17. Therefore, the amount of calculation can be reduced as compared to the example shown in the square 153 in FIG. 15 (the case where the definition of the movement is the highest definition). In other words, the load of the skeleton pose transformation processing can be reduced.

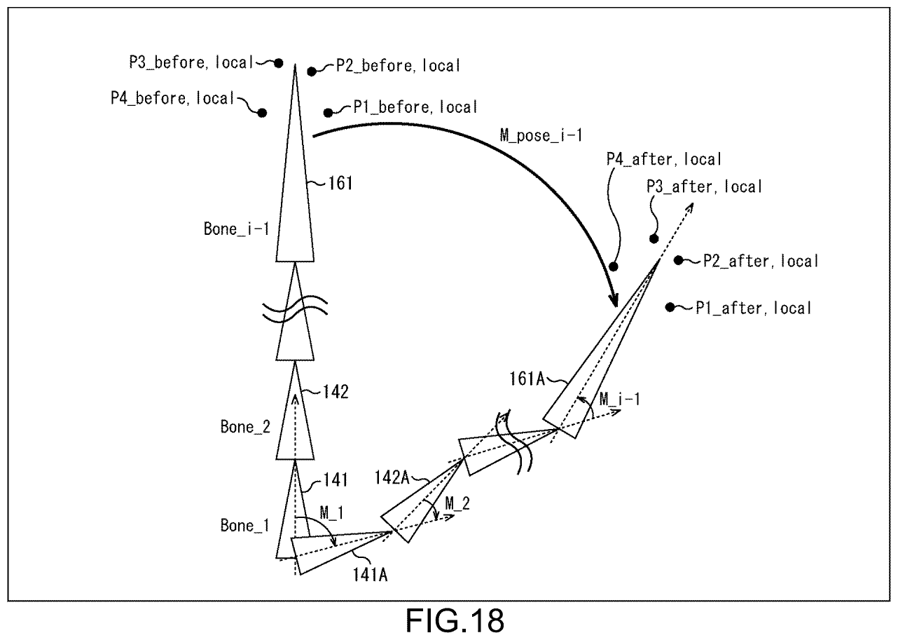

In contrast, it is assumed that the present technology described above is applied to perform the animation processing of FIG. 13 while the definition of the movement structure is lowered. For example, it is assumed that Bone_i is omitted in the skeleton information (Bone_(i_1) and Bone_i are regarded as one bone). That is, as shown in FIG. 18, it is assumed that the initial pose of Bone_(i−1) is the pose 161. Then, it is assumed that Bone_(i−1) changes from the pose 161 to the pose 161A by this animation processing.

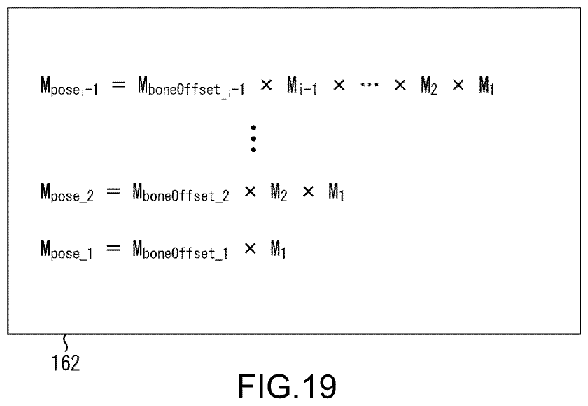

In this case, in the calculation of the skeleton pose transformation processing, the entire calculation for deriving M_(pose_i) can be omitted as shown in the square 162 in FIG. 19. Therefore, the amount of calculation can be further reduced as compared to the case of the example shown in the square 154 in FIG. 17 (the case where only the definition of the movement is lowered). In other words, the load of the skeleton pose transformation processing can be further reduced.

It is noted that even if the bone movement is omitted or the number of bones is reduced, each vertex of the mesh is linked to one of the bones by the skin weight information. Therefore, the load of the skinning processing does not depend on the bone movement or the number of bones. In other words, the loads of the skinning processing in the examples described above are substantially the same.

In other words, by applying the present technology, it is possible to suppress an increase in the load of the reproduction processing as compared to the case where the method described in Non-Patent Literature 1 is applied.

### <Method 1-2>

Content to be reproduced may include motion data in addition to a Skinned model. For example, in the first information processing apparatus described above, the content reproduction unit may reproduce the content further including motion data indicating a movement of the 3D model.

In that case, the definition of the motion data (the definition of the movement of the 3D model) may be made variable, and the definition may be controlled. In other words, when Method 1 described above is applied, as shown on the third row from the top of the table shown in FIG. 6, the definition of the motion data may be further controlled (Method 1-2). In other words, the definition of the motion data may be controlled together with the static 3D model, skeleton information, and skin weight information described above.

For example, the motion data may have variations in the definition of the movement, and one of the variations may be applied. For example, in FIGS. 7 and 8, High motion data 112-1 and Low motion data 112-2 may be prepared, and one of those data may be applied. In other words, the motion data may be hierarchized according to the definition of the movement. For example, motion data of a plurality of definitions such as high-definition motion data and low-definition motion data may be prepared as candidates, and motion data of a desired definition may be selected and applied from among the candidates. In the present specification, this hierarchy will also be referred to as LoD. It is noted that the number of variations (number of LoDs) of this motion data may be any number as long as it is two or more. Of course, it is also possible to generate and provide motion data of a freely set definition without preparing the variations (plurality of candidates).

As shown in FIG. 4, the motion data indicates a movement of a 3D model based on the skeleton information (bone structure). That is, as shown in FIGS. 7 and 8, the definition of the motion data (i.e., the definition of the movement of the 3D model) depends on the definition of the skeleton information (the definition of the movement structure). For example, the definition of the motion data may correspond to the definition of the skeleton information.

For example, in FIGS. 7 and 8, the High motion data 112-1 indicates the movement of the bone structure of the High skeleton information 121-1. That is, the High motion data 112-1 corresponds to the High skeleton information 121-1. Further, the Low motion data 112-2 indicates the movement of the bone structure of the Low skeleton information 121-2. That is, the Low motion data 112-2 corresponds to the Low skeleton information 121-2. Therefore, for example, the High motion data 112-1 only needs to be applied when the High skeleton information 121-1 is applied, and the Low motion data 112-2 only needs to be applied when the Low skeleton information 121-2 is applied. In other words, the High skeleton information 121-1 may be applied when the High motion data 112-1 is applied, and the Low skeleton information 121-2 may be applied when the Low motion data 112-2 is applied.

In this manner, by controlling the definition of the movement in accordance with the control of the definition of the movement structure, it is possible to suppress an increase in the load of the reproduction processing while suppressing lowering of the quality of a user experience, in both cases where the High skeleton information 121-1 and the Low skeleton information 121-2 are applied.

### <Content Distribution>

It is noted that the content including the Skinned model and motion data described above may be distributed. That is, this content may be provided from one device to another device. For example, a distribution server may distribute this content, and a reproduction device may acquire and reproduce the content.

For example, the first information processing apparatus may further include a content acquisition unit which acquires, as the content, the static 3D model, the skeleton information, the motion data, and the skin weight information. Then, the content reproduction unit may reproduce the acquired content.

The present technology may be applied even when content is distributed in this manner. That is, the definition of the static 3D model and the definition of the skeleton information may be controlled independently of each other. For example, the reproduction device that reproduces content may set the definition of the static 3D model and the definition of the skeleton information independently of each other, and request the static 3D model, the skeleton information, and the skin weight information that correspond to the set definitions. A distribution device that distributes content may acquire the request and supply the requested content (the requested static 3D model, skeleton information, and skin weight information) to the reproduction device. Then, the reproduction device may acquire and reproduce the supplied content. With such a configuration, as described above, it is possible to suppress an increase in the load of the reproduction processing while suppressing lowering of the quality of a user experience.

It is noted that such distribution accompanied by the control of the definitions may be performed using control information. For example, this control information may be provided to the reproduction device. This control information indicates specifications of content that can be distributed, a location and/or identification information of the content, and/or the like, and the reproduction device can set the definitions of the static 3D model and the skeleton information based on the information, and/or request the static 3D model and/or skeleton information with the set definition.

For example, the first information processing apparatus may further include a control information acquisition unit which acquires control information for controlling supply of the content. Then, the static 3D model definition setting unit may set the definition of the static 3D model based on the control information. Further, the skeleton information definition setting unit may set the definition of the skeleton information based on the control information. Also in this case, the definition of the skeleton information is set independently of the definition of the static 3D model. Although details of the control information will be described later, by using this control information, the reproduction device (first information processing apparatus) can more easily set the definitions of the static 3D model and the skeleton information. In addition, the reproduction device (first information processing apparatus) can easily select the skin weight information and the motion data based on this control information.

As described above, the control information can also be used to acquire (request) content. For example, the first information processing apparatus may further include a content acquisition unit which acquires, as the content, the static 3D model and the skeleton information having the definitions set independently of each other and the skin weight information corresponding to the static 3D model and the skeleton information. Then, the content reproduction unit may reproduce the acquired content. It is noted that the content may include the motion data. That is, the motion data may also be acquired based on the control information. By using the control information in this manner, the reproduction device (first information processing apparatus) can more easily acquire the content (the static 3D model, the skeleton information, the skin weight information, the motion data, and the like).

### <Control Information>

A content of the control information is arbitrary. For example, the content may be a data format with the following three points.
Point 1: Since there is a one-to-one correspondence between the skeleton information and the motion data, those pieces of information are also integrated as a data structure. Further, the LoD of one of those pieces of information may be determined by selecting the LoD of the other one of those pieces of information.
Point 2: A data structure that allows the three types of data, that is, the skeleton information and motion data, the static 3D model, and the skin weight information, to individually have variations is set.
Point 3: Based on the LOD of the static 3D model and the LOD of the skeleton information (or the LOD of the motion data), linked data with which it is possible to discriminate which of the three types of data, that is, the skeleton information and motion data, the static 3D model, and the skin weight information, is to acquire what variations is provided.

### <Method 1-3>

Further, this control information may be information in any format. For example, this control information may be described in glTF2.0. In other words, when Method 1 described above is applied, as shown on the fourth row from the top of the table shown in FIG. 6, the distribution of content may be controlled using glTF2.0 (Method 1-3). glTF2.0 may be constituted of a scene description file described in JSON, a binary file constituting a 3D object and/or animation data to be referenced in a glTF file, and still image data of png and jpg that are used as textures of 3D objects.

The existing glTF2.0 function for handling a Skinned model has a structure in which the motion data is uniquely determined once the skeleton is determined, thus satisfying the point 1 described above. However, the skeleton information, the static 3D model, and the skin weight information are integrated, making it impossible to express individual variations. Therefore, the point 2 described above is not satisfied.

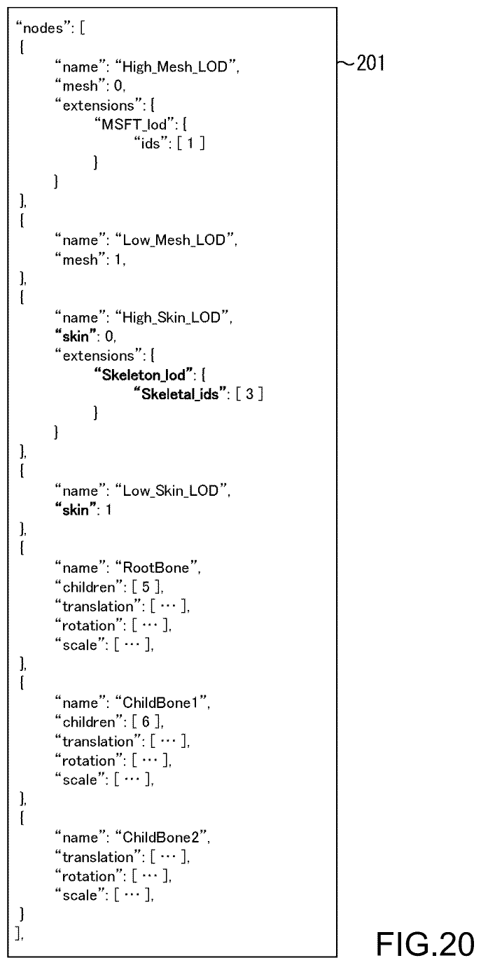

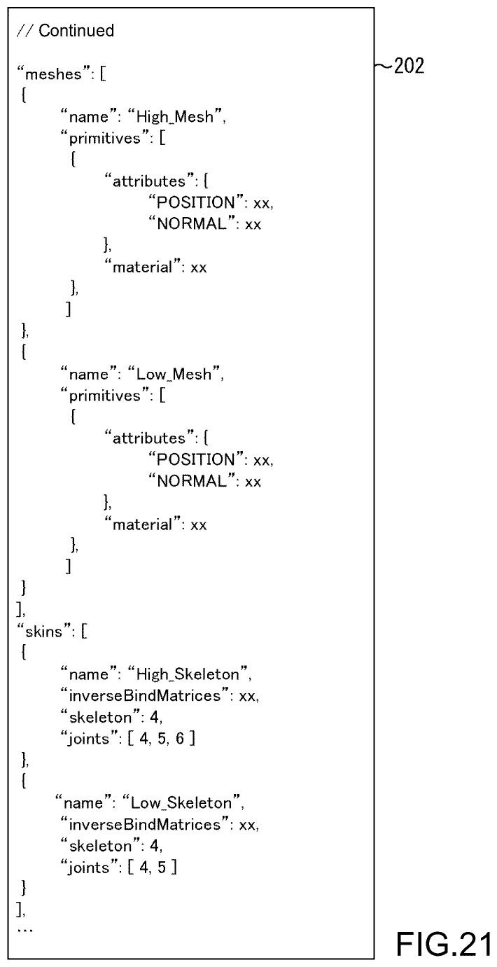

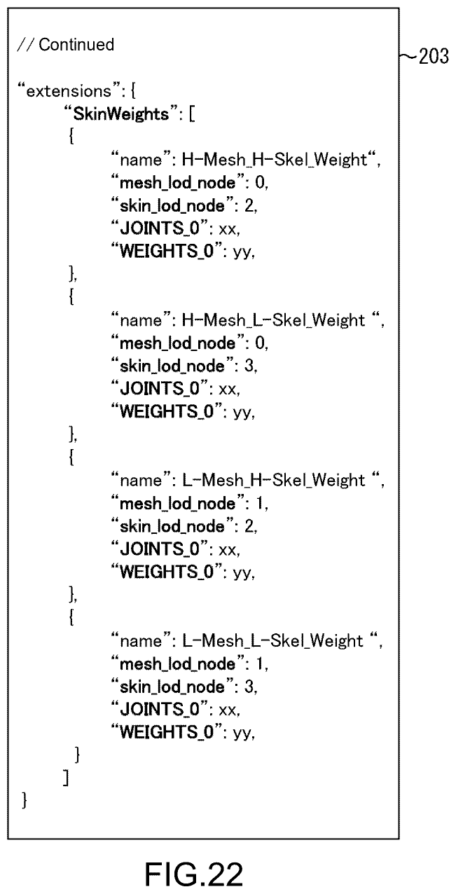

In this regard, a function of glTF2.0 called MSFT_lod that expresses LOD variations of mesh data (static 3D model) may be used. The syntax 201 shown in FIG. 20, the syntax 202 shown in FIG. 21, and the syntax 203 shown in FIG. 22 are each an example of a syntax that has been extended to satisfy this point using this function. Although the descriptions are given divisionally in FIGS. 21 and 22 for convenience of descriptions, the syntax 202 is a syntax that follows the syntax 201, and the syntax 203 is a syntax that follows the syntax 202.

As shown in the syntax 201, a conventional MSFT_lod extension is used for the LoD expression of a mesh (static 3D model). In contrast, in the LoD expression of the skeleton information, “Skeleton_lod” is used a new extension. In this example, the usage of this “Skeleton_lod” is similar to that of “MSFT_lod”. The node including this “Skeleton_lod” indicates the skeleton information of LoD0 (H-LOD). The lower-order LoDs are represented by the nodes indicated by “Skeletal ids” (array of “nodes” indices).

Further, as shown in the syntax 203, the skin weight information is expressed by a “SkinWeights” node extended using a new extension, together with “nodes” index information (“mesh_lod_node”, “skin_lod_node”) indicating the LoD of the corresponding mesh (static 3D model) and the LOD of the Skin (skeleton information).

By describing the control information in this manner, the points 1 to 3 described above can be satisfied, and an increase in the load of the reproduction processing can be suppressed while suppressing lowering of the quality of a user experience.

### <Method 1-4>

Further, this control information may be MPD (Media Presentation Description) used when distributing content data using MPEG-DASH (Moving Picture Experts Group Dynamic Adaptive Streaming over HTTP (Hypertext Transfer Protocol)). In other words, when Method 1 described above is applied, as shown on the fifth row from the top of the table shown in FIG. 6, the definition of the movement structure, and the like may be controlled using the MPD (Method 1-4). The MPD is control information for distributing content data.

In this case, the static 3D model, the skeleton information, the skin weight information, and the motion data as the content data are packaged as a DASH segment file. The static 3D model, the skeleton information, and the skin weight information are static data that do not change in the time direction. In contrast, the motion data is dynamic data that may change in the time direction. In the present specification, the characteristics that do not change in the time direction will also be referred to as “static”. In addition, in the present specification, the characteristics that may change in the time direction will also be referred to as “dynamic”.

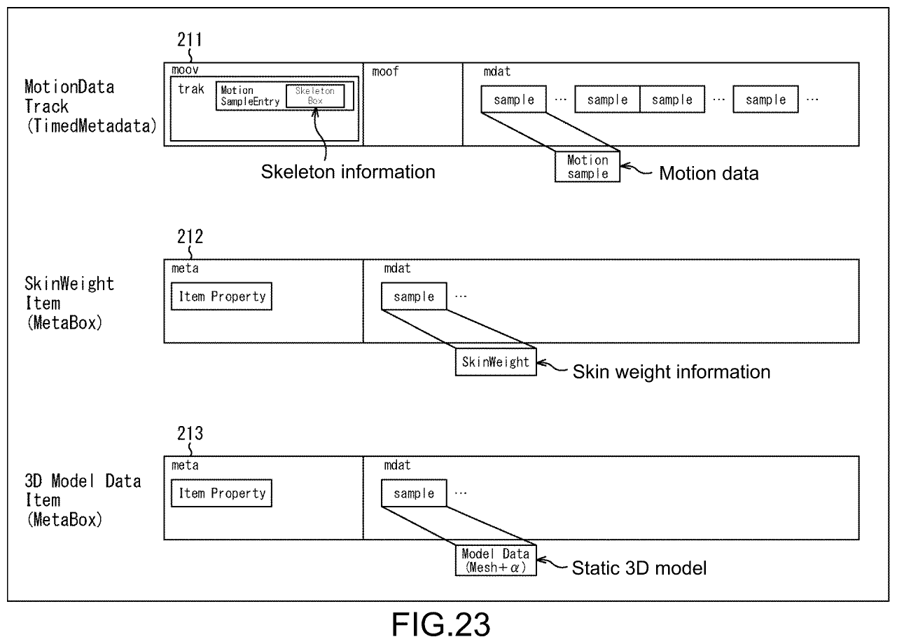

In this regard, these pieces of data are packaged as shown in FIG. 23, for example. FIG. 23 is a diagram showing a configuration example of an MP4 file. As shown in FIG. 23, skeleton information and motion data are stored in a motion data track (MotionData Track) 211. The motion data track (MotionData Track) 211 is a timed metadata track (“Timed Metadata Track”) that stores dynamic data. Motion data which is the dynamic data is stored in a media data box (MediaDataBox (‘mdat’)) of this motion data track 211. Furthermore, skeleton information (static data) in a one-to-one correspondence with this motion data is stored as a sample entry (Motion SampleEntry) in a movie box (MovieBox (‘moov’)) of this motion data track (MotionData Track) 211.

A skin weight item (SkinWeightItem) 212 is a meta box (MetaBox) that stores a meta item. The skin weight information which is the static data is stored in the media data box of this skin weight item 212. A 3D model data item (3D Model Data Item) 213 is a meta box (MetaBox) that stores a meta item. The static 3D model which is the static data is stored in the media data box of this 3D model data item 213.

As described above in the point 2, the skeleton information and motion data, the static 3D model, and the skin weight information are stored in different files so that these three types of data can have variations independent of each other. That is, as described above, the skin weight information is stored in the skin weight item 212 different from the motion data track 211. The static 3D model is stored in the 3D model data item 213 different from the motion data track 211. It is noted that the variations of these three types of data are also stored in different files.

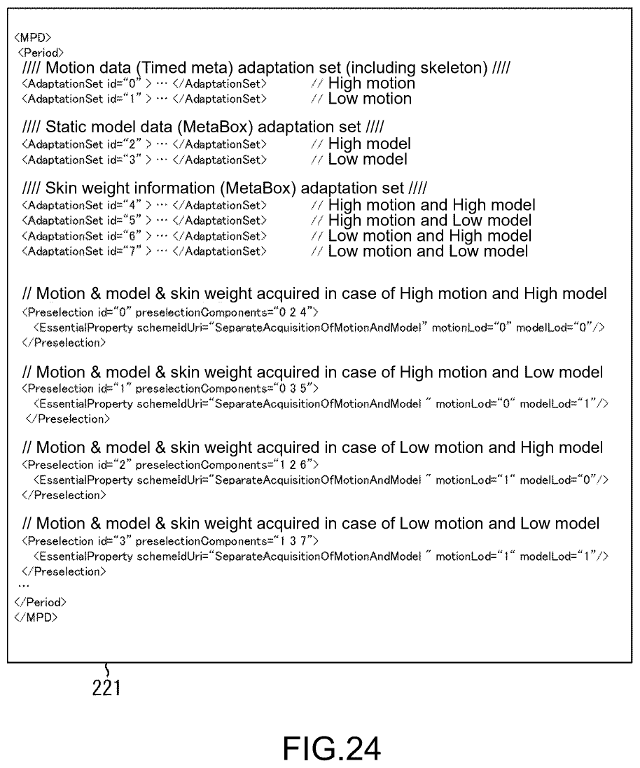

FIG. 24 shows a description example of the MPD in a case where the skeleton information and motion data, the static 3D model, and the skin weight information are stored in different files for each of the variations. In the description example 221 shown in FIG. 24, the files storing the variations of the skeleton information and motion data, the static 3D model, and the skin weight information are referenced by adaptation sets (AdaptationSet). Also in this description example, each of the adaptation sets is linked by linked data described above in the point 3. It is noted that in this description example 221, two variations (H-LoD and L-LoD) are prepared for both the skeleton information and the static 3D model.

In the preselection (Preselection), the adaptation sets that reference the skeleton information and motion data, the adaptation sets that reference the static 3D model, and the adaptation sets that reference the skin weight information are linked. Also in the preselection, as described above in the point 3, a new descriptor that specifies data corresponding to two LoD values, that is, the LoD of the static 3D model and the LoD of the skeleton information (=the LoD of the motion data), is indicated using the essential property (EssentialProperty).

By describing the control information in this manner, the points 1 to 3 described above can be satisfied, and an increase in the load of the reproduction processing can be suppressed while suppressing lowering of the quality of a user experience.

### <Method 1-5>

Alternatively, this control information may be USD (Universal Scene Description). In other words, when Method 1 described above is applied, as shown on the bottom row of the table shown in FIG. 6, the definition of the movement structure, and the like may be controlled using the USD (Method 1-4). The USD is a scene description for describing a scene in a three-dimensional space.

The USD has a mechanism for handling a Skinned model called SkelRoot prim and a mechanism for handling the LoD. In the conventional USD function for handling a Skinned model, the motion data is uniquely determined once the skeleton is determined. Therefore, the point 1 described above is satisfied. However, the mesh (static 3D model) and the skin weight information are integrated, and individual variations cannot be expressed. Therefore, the point 2 described above is not satisfied. It is noted that a configuration that enables the skeleton information to be switched uniquely can be provided by using a unique variantSet prim for the skeleton information as well. However, since the skin weight information and the static 3D model are explicitly linked in a one-to-one correspondence relationship, there is a fear that it will be impossible to recreate the intended motion.

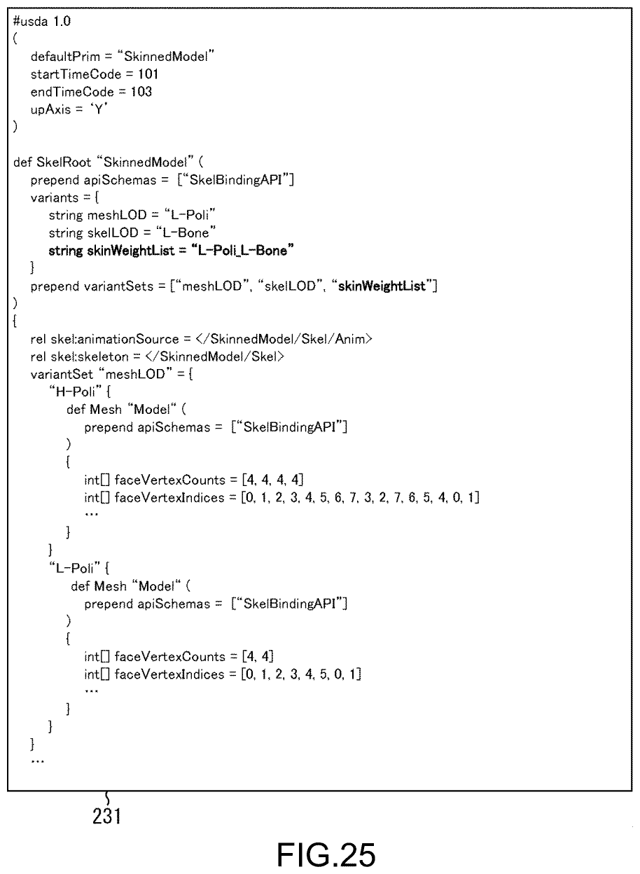

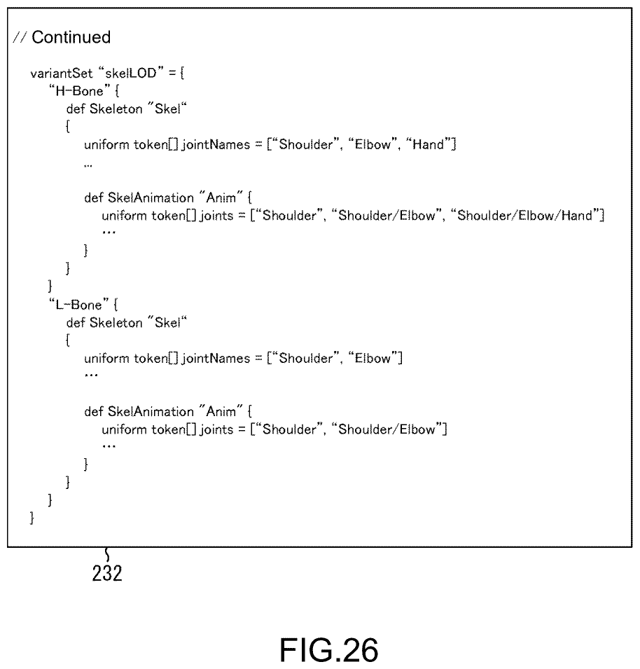

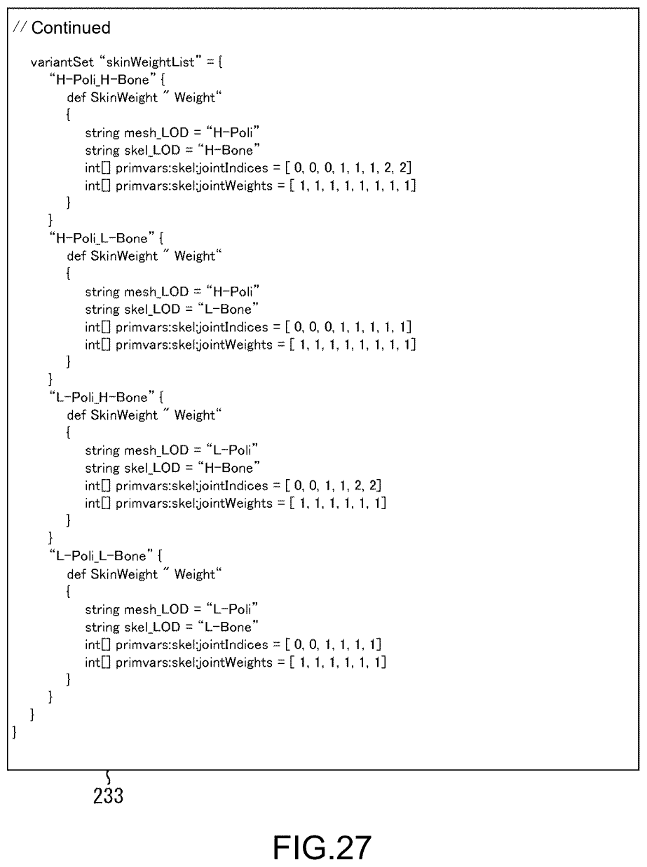

In this regard, the control information may be described as in the description examples shown in FIGS. 25 to 27. The description example 231 in FIG. 25, the description example 232 in FIG. 26, and the description example 233 in FIG. 27 show the USD description examples. Although the descriptions are given divisionally in FIGS. 25 to 27 for convenience of descriptions, the description example 232 is a description example that follows the description example 231, and the description example 233 is a description example that follows the description example 232. In the case of these description examples, the skin weight information embedded in the “jointIndices” and “jointWeights” nodes, which are the attributes in the “Mesh” prim, is extracted, and a “SkinWeight” prim is newly defined for handling the skin weight information individually. This prim has two attributes of string-type “mesh_LOD” and “skel_LOD” that represent the Variant names of the “Mesh” prim and the “Skeleton” prim that are referenced by its own skin weight information, and a correct combination is linked by this information. By using variantSet also for this “SkinWeight” prim, it is possible to express individual variations.

By describing the control information in this manner, the points 1 to 3 described above can be satisfied, and it is possible to suppress an increase in the load of the reproduction processing while suppressing lowering of the quality of a user experience.

### <Provision of Control Information by Distribution Device>

This control information may be provided by, for example, the distribution device that distributes content. For example, a second information processing apparatus may include: a control information supply unit which supplies control information for controlling supply of content including a static 3D model indicating an appearance of a 3D model, skeleton information indicating a movement structure of the 3D model, and skin weight information indicating a correspondence relationship between the appearance and the movement structure; and a content supply unit which supplies the content including the static 3D model having a definition that has been requested based on the control information, the skeleton information having a definition that has been requested based on the control information, and the skin weight information that has been requested based on the control information.

In addition, a second information processing method executed by the second information processing apparatus may include: supplying control information for controlling supply of content including a static 3D model indicating an appearance of a 3D model, skeleton information indicating a movement structure of the 3D model, and skin weight information indicating a correspondence relationship between the appearance and the movement structure; and supplying the content including the static 3D model having a definition that has been requested based on the control information, the skeleton information having a definition that has been requested based on the control information, and the skin weight information that has been requested based on the control information.

It is noted that this control information may be information that expresses, independently of one another, variations of the definition of the static 3D model, variations of the definition of the skeleton information, and variations of the skin weight information.

By providing such control information, the reproduction device (first information processing apparatus) can set the definitions of the static 3D model and the skeleton information based on the control information, select the skin weight information, and acquire the content including those pieces of information, as described above. In other words, the distribution device (second information processing apparatus) Can suppress an increase in the load of reproduction processing while suppressing lowering of the quality of a user experience.

It is noted that this control information may be prepared in advance, or may be generated. For example, the second information processing apparatus may further include a control information generation unit which generates the control information based on the content. Then, the control information supply unit may supply the generated control information. With such a configuration, the distribution device (second information processing apparatus) can provide the control information corresponding to the content to be distributed even when the control information to be provided is not prepared.

It is noted that the content to be distributed may be prepared in advance, or may be generated. For example, the static 3D model may be prepared in advance, but may also be generated. For example, the second information processing apparatus may further include a static 3D model generation unit which generates the variations of the definition of the static 3D model. Then, the control information generation unit may generate the control information that expresses the generated variations of the definition of the static 3D model. With such a configuration, the distribution device (second information processing apparatus) can generate and provide the static 3D model even when the static 3D model is not prepared.

The method of generating this static 3D model may be any method. For example, a static 3D model may be generated by capturing a real object. In addition, the variations of the definition may be generated from one static 3D model. For example, in the second information processing apparatus, the static 3D model generation unit may generate the static 3D model having a lower definition based on the static 3D model having a highest definition. For example, the static 3D model generation unit may generate the static 3D model having a lower definition by decimating information of the static 3D model having the highest definition. For example, when the static 3D model is point cloud data, some points in the point cloud may be decimated. Alternatively, when the static 3D model is mesh data, the number of faces may be reduced by decimating some vertices and/or connections, and/or the like. By such a method, the distribution device (second information processing apparatus) can easily generate the variations of the definition of the static 3D model.

Further, the skeleton information may be prepared in advance, or may be generated. For example, the second information processing apparatus may further include a skeleton information generation unit which generates the variations of the definition of the skeleton information. Then, the control information generation unit may generate the control information that expresses the generated variations of the definition of the skeleton information. With such a configuration, the distribution device (second information processing apparatus) can generate and provide the skeleton information even when the skeleton information is not prepared.

The method of generating this skeleton information may be any method. For example, the skeleton information may be generated by capturing a real object. Further, the variations of the definition may be generated from one piece of skeleton information. For example, in the second information processing apparatus, the skeleton information generation unit may generate the skeleton information having a lower definition based on the skeleton information having a highest definition. For example, the skeleton information generation unit may generate the skeleton information having a lower definition by decimating bones of the skeleton information having the highest definition. In that case, the skeleton information generation unit may generate skeleton information of one layer lower by, for example, deleting the terminal bone. In other words, the skeleton information of each layer may be generated by sequentially deleting the bones from the terminal bone. By such a method, the distribution device (second information processing apparatus) can easily generate the variations of the definition of the skeleton information.

The skin weight information may be prepared in advance, or may be generated. For example, the second information processing apparatus may further include a skin weight information generation unit which generates the variations of the skin weight information based on the variations of the definition of the static 3D model and the variations of the definition of the skeleton information. Then, the control information generation unit may generate the control information that expresses the generated variations of the skin weight information. With such a configuration, the distribution device (second information processing apparatus) can generate and provide the skin weight information even when the skin weight information is not prepared.

The method of generating this skin weight information may be any method. For example, the variations may be generated from one piece of skin weight information. For example, in the second information processing apparatus, the skin weight information generation unit may generate the skin weight information having a content corresponding to a case where at least one of the static 3D model or the skeleton information has the lower definition, based on the skin weight information having a content corresponding to a case where the static 3D model and the skeleton information have the highest definitions. Further, the variations of the skin weight information may be generated based on the variations of the definitions of the static 3D model and the skeleton information. For example, the variations of the skin weight information may be generated according to a lowering state of the information of each LOD of the static 3D model and the skeleton information. By such a method, the distribution device (second information processing apparatus) can easily generate the variations of the definition of the skin weight information.

It is noted that the motion data may also be distributed as the content. That is, the content to be distributed may include the motion data. In that case, the distribution of the motion data may be controlled by the control information described above (Method 1-2). For example, the control information may further express variations of the definition of the motion data indicating the movement of the 3D model. Then, in the second information processing apparatus, the content supply unit may supply the content including the motion data having the definition that has been requested based on the control information. With such a configuration, the reproduction device (first information processing apparatus) can set the definition of the motion data based on the control information, and acquire the content including the motion data, as described above. That is, the distribution device (second information processing apparatus) can suppress an increase in the load of the reproduction processing while suppressing lowering of the quality of a user experience.

It is noted that the motion data may be prepared in advance, or may be generated. For example, the second information processing apparatus may further include a motion data generation unit that generates variations of the definition of the motion data. Then, the control information generation unit may generate the control information that expresses the generated variations of the definition of the motion data. With such a configuration, the distribution device (second information processing apparatus) can generate and provide the motion data even when the motion data is not prepared.

The method of generating this motion data may be any method. For example, the motion data may be generated by capturing a real object. Further, the variations of the definition may be generated from one piece of motion data. For example, in the second information processing apparatus, the motion data generation unit may generate the motion data having a lower definition based on the motion data having a highest definition. Further, the variations of the definition of the motion data may be generated in accordance with the variations of the skeleton information. By such a method, the distribution device (second information processing apparatus) can easily generate the variations of the definition of the motion data.

It is noted that the control information generated by the control information generation unit may be information in any format. For example, this control information may be described in glTF2.0 (Method 1-3). Alternatively, the control information may be MPD (Method 1-4). Alternatively, the control information may be Universal Scene Description (Method 1-5).

### <Regarding Method>

In other words, each of the methods described above may be applied to not only the first information processing apparatus, but also the second information processing apparatus. Each of the methods described above may be applied in combination with other methods as long as no contradiction is caused. For example, the plurality of methods out of Methods 1-1 to 1-5 shown in the table shown in FIG. 6 may be applied in combination. Of course, the methods shown in FIG. 6 may be applied in combination with other methods.

It is noted that in the descriptions of the present specification, the higher-order methods may include the lower-order methods. In other words, applying Method 1 may include applying any one or more of Methods 1-1 to 1-5. Therefore, for example, the case described as “Method 1 is applied” may include the case of applying any one or more of Methods 1-1 to 1-5.

### 4. First Embodiment

### <Distribution Device>

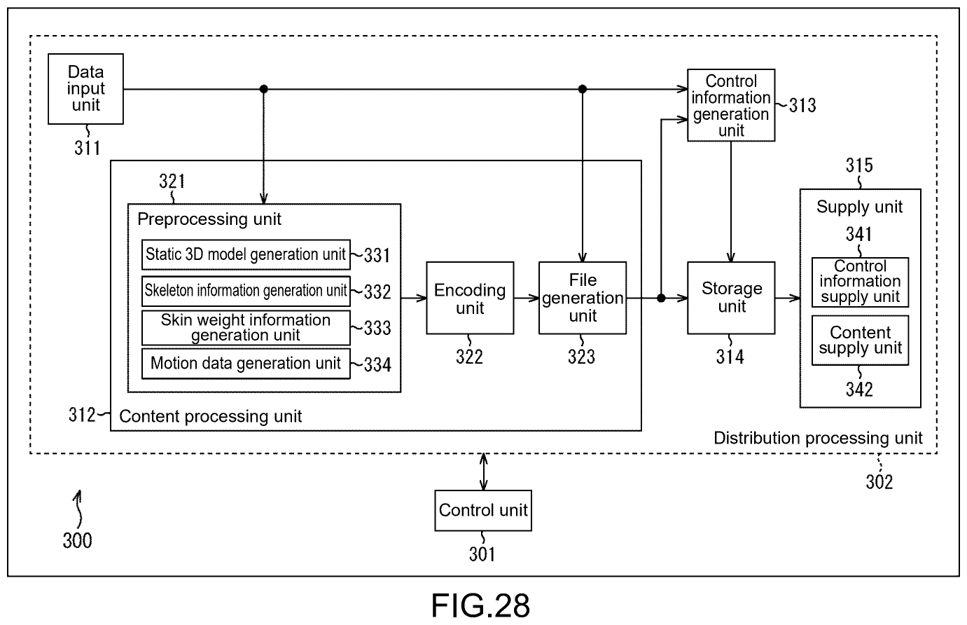

The present technology described above may be applied to any device. FIG. 28 is a block diagram showing an example of a configuration of the distribution device, which is one aspect of the information processing apparatus to which the present technology is applied. The distribution device 300 shown in FIG. 28 is a device that encodes a 3D model (Skinned model) of an object and/or motion data thereof, and distributes the data to the reproduction device as content data. The distribution device 300 is also a device that supplies, to the reproduction device, control information for controlling provision of skeleton information indicating a movement structure of the 3D model to be distributed, in accordance with the definition of the movement structure. Of course, the distribution device 300 may execute processing other than these.

It is noted that FIG. 28 shows the main processing units, data flows, and the like, and not everything is shown in FIG. 28. In other words, in distribution device 300, there may be processing units that are not shown as blocks in FIG. 28, and there may be processing and data flows that are not indicated as arrows and the like in FIG. 28.

As shown in FIG. 28, the distribution device 300 includes a control unit 301 and a distribution processing unit 302. The control unit 301 controls each processing unit of the distribution processing unit 302. The distribution processing unit 302 is controlled by the control unit 301 to perform processing related to the distribution of content data and the like. Of course, the control unit 301 and the distribution processing unit 302 may perform other processing.

This distribution processing unit 302 includes a data input unit 311, a content processing unit 312, a control information generation unit 313, a storage unit 314, and a supply unit 315. Further, the content processing unit 312 includes a preprocessing unit 321, an encoding unit 322, and a file generation unit 323. Further, the preprocessing unit 321 includes a static 3D model generation unit 331, a skeleton information generation unit 332, a skin weight information generation unit 333, and a motion data generation unit 334. Further, the supply unit 315 includes a control information supply unit 341 and a content supply unit 342.

The data input unit 311 performs processing related to acquisition of data to be supplied to the distribution device 300. For example, the data input unit 311 may acquire information such as the skeleton information, the static 3D model, the skin weight information, and the motion data supplied from outside the distribution device 300. At that time, the data input unit 311 may acquire only the information having a highest definition (information of the highest-order LoD) for each piece of information. Furthermore, the data input unit 311 may acquire not only the information having a highest definition (information of the highest-order LoD), but also information of lower-order LoDs, for each piece of information. Furthermore, the data input unit 311 may acquire other information supplied from outside the distribution device 300. The data input unit 311 may supply a part or all of the acquired information to the preprocessing unit 321. Furthermore, the data input unit 311 may supply a part or all of the acquired information to the file generation unit 323. Furthermore, the data input unit 311 may supply a part or all of the acquired information to the control information generation unit 313. Of course, the data input unit 311 may also perform other processing.

The content processing unit 312 performs processing related to content data (Skinned model, motion data, and/or the like). For example, the content processing unit 312 may acquire content data supplied from the data input unit 311. Further, the content processing unit 312 may preprocess and encode the content data and store the data in a file (will also be referred to as a content file). Further, the content processing unit 312 may supply the content file to the control information generation unit 313. Further, the content processing unit 312 may supply the content file to the storage unit 314. Of course, the content processing unit 312 may also perform other processing.

The control information generation unit 313 performs processing related to the generation of control information related to the provision of content data. For example, the control information generation unit 313 may acquire information (e.g., content data and/or the like) supplied from the data input unit 311. Further, the control information generation unit 313 may acquire a content file supplied from the content processing unit 312 (file generation unit 323). Further, the control information generation unit 313 may generate control information based on these acquired pieces of information. Further, the control information generation unit 313 may store the control information in a file (will also be referred to as a control file). Further, the control information generation unit 313 may supply the generated control file (including control information) to the storage unit 314. Of course, the control information generation unit 313 may also perform other processing.

The storage unit 314 includes an arbitrary storage medium and performs processing related to the storage of information. For example, the storage unit 314 may acquire a content file supplied from the content processing unit 312, and store the content file using its own storage medium. Further, the storage unit 314 may acquire a control file (including control information) supplied from the control information generation unit 313, and store the control file using its own storage medium. Further, the storage unit 314 may read out the content file and/or the control file stored in the storage medium, and supply the file(s) to the supply unit 315. Of course, the storage unit 314 may also perform other processing, such as storing other information.

The supply unit 315 includes a communication unit and performs processing related to the supply (distribution) of a control file, a content file, and the like by communicating with other devices using the communication unit. For example, the supply unit 315 may acquire a control file supplied from the storage unit 314, and supply the control file to the reproduction device that reproduces the content file. Further, the supply unit 315 may acquire a request for a content file supplied from the reproduction device based on control information stored in the control file. Further, the supply unit 315 may read out the requested content file from the storage unit 314, and supply the content file to the reproduction device that is the request source. For example, the supply unit 315 may read out a content file that stores content data of an LoD that has been specified in the request (skeleton information, static 3D model, skin weight information, motion data, and the like) from the storage unit 314, and supply the content file to the reproduction device that is the request source. Of course, the supply unit 315 may also perform other processing, such as transmitting and/or receiving other information.

The preprocessing unit 321 of the content processing unit 312 executes processing related to the preprocessing of content data (processing performed before encoding). For example, the preprocessing unit 321 may acquire content data (skeleton information, static 3D model, skin weight information, motion data, and the like) supplied from the data input unit 311. Further, the preprocessing unit 321 may perform preprocessing on the content data. Further, the preprocessing unit 321 may supply the preprocessed content data to the encoding unit 322. Of course, the preprocessing unit 321 may also perform other processing.

The encoding unit 322 executes processing related to encoding of content data. For example, the encoding unit 322 may acquire content data supplied from the preprocessing unit 321. Further, the encoding unit 322 may encode the content data using a predetermined encoding method, to generate encoded data thereof. Further, the encoding unit 322 may supply the generated encoded data of the content data to the file generation unit 323. Of course, the encoding unit 322 may also perform other processing.

The file generation unit 323 performs processing related to the generation of a content file. For example, the file generation unit 323 may acquire encoded data of the content data supplied from the encoding unit 322. Further, the file generation unit 323 may acquire information supplied from the data input unit 311. Further, the file generation unit 323 may also store the acquired encoded data and the like in a content file. The file generation unit 323 may also supply the generated content file to the control information generation unit 313. Further, the file generation unit 323 may supply the content file to the storage unit 314. Of course, the file generation unit 323 may also perform other processing.

The static 3D model generation unit 331 performs processing related to the generation of a static 3D model. For example, the static 3D model generation unit 331 may generate a static 3D model. Further, the static 3D model generation unit 331 may acquire a static 3D model supplied from the data input unit 311, and generate variations of the definition of the static 3D model using the static 3D model. Further, the static 3D model generation unit 331 may supply the generated static 3D model (variations of the definition of the static 3D model) to the encoding unit 322 as content data. Of course, the static 3D model generation unit 331 may also perform other processing.

The skeleton information generation unit 332 performs processing related to the generation of skeleton information. For example, the skeleton information generation unit 332 may generate skeleton information. Further, the skeleton information generation unit 332 may acquire skeleton information supplied from the data input unit 311, and generate variations of the definition of the skeleton information using the skeleton information. Further, the skeleton information generation unit 332 may supply the generated skeleton information (variations of the definition of the skeleton information) to the encoding unit 322 as content data. Of course, the skeleton information generation unit 332 may also perform other processing.

The skin weight information generation unit 333 performs processing related to the generation of skin weight information. For example, the skin weight information generation unit 333 may generate skin weight information. Further, the skin weight information generation unit 333 may acquire skin weight information supplied from the data input unit 311, and generate variations of the skin weight information using the skin weight information. Further, the skin weight information generation unit 333 may supply the generated skin weight information (variations of the skin weight information) to the encoding unit 322 as content data. Of course, the skin weight information generation unit 333 may also perform other processing.

The motion data generation unit 334 performs processing related to the generation of motion data. For example, the motion data generation unit 334 may generate motion data. Further, the motion data generation unit 334 may acquire motion data supplied from the data input unit 311, and generate variations of the definition of the motion data using the motion data. Further, the motion data generation unit 334 may supply the generated motion data (the variations of the definition of the motion data) to the encoding unit 322 as content data. Of course, the motion data generation unit 334 may also perform other processing.

The control information supply unit 341 performs processing related to the supply of control information. For example, the control information supply unit 341 may acquire a control file supplied from the storage unit 314, and supply the control file to the reproduction device that reproduces the content file. Of course, the control information supply unit 341 may also perform other processing, such as transmitting and/or receiving other information.

The content supply unit 342 performs processing related to the supply of content (skeleton information, static 3D model, skin weight information, motion data, and the like). For example, the content supply unit 342 may acquire a request for a content file supplied from the reproduction device based on the control information. Further, the content supply unit 342 may read out the requested content file from the storage unit 314, and supply the content file to the reproduction device that is the request source. For example, the content supply unit 342 may read out a content file that stores content data of an LoD that has been specified in the request (skeleton information, static 3D model, skin weight information, motion data, and the like) from the storage unit 314, and supply the content file to the reproduction device that is the request source. Of course, the content supply unit 342 may also perform other processing, such as transmitting and/or receiving other information.

The present technology described above in <3. Control of definition related to 3D model> may be applied to the distribution device 300 having such a configuration. For example, Method 1 described above may be applied to this distribution device 300.

For example, the control information supply unit 341 may supply control information for controlling supply of content including a static 3D model indicating an appearance of a 3D model, skeleton information indicating a movement structure of the 3D model, and skin weight information indicating a correspondence relationship between the appearance and the movement structure. Further, the content supply unit 342 may supply the content including the static 3D model having a definition that has been requested based on the control information, the skeleton information having a definition that has been requested based on the control information, and the skin weight information that has been requested based on the control information. It is noted that this control information may express, independently of one another, variations of the definition of the static 3D model, variations of the definition of the skeleton information, and variations of the skin weight information.

Further, the control information generation unit 313 may generate the control information based on the content. Then, the control information supply unit 341 may supply the generated control information.

Further, the static 3D model generation unit 331 may generate the variations of the definition of the static 3D model. Then, the control information generation unit 313 may generate the control information that expresses the generated variations of the definition of the static 3D model. It is noted that the static 3D model generation unit 331 may generate the static 3D model having a lower definition based on the static 3D model having a highest definition.

The skeleton information generation unit 332 may generate the variations of the definition of the skeleton information. Then, the control information generation unit 313 may generate the control information that expresses the generated variations of the definition of the skeleton information. It is noted that the skeleton information generation unit 332 may generate the skeleton information having a lower definition based on the skeleton information having a highest definition.

Further, the skin weight information generation unit 333 may generate the variations of the skin weight information based on the variations of the definition of the static 3D model and the variations of the definition of the skeleton information. Then, the control information generation unit 313 may generate the control information that expresses the generated variations of the skin weight information. It is noted that the skin weight information generation unit 333 may generate the skin weight information having a content corresponding to a case where at least one of the static 3D model or the skeleton information has the lower definition, based on the skin weight information having a content corresponding to a case where the static 3D model and the skeleton information have the highest definitions.

Further, the control information may further express variations of a definition of motion data indicating a movement of the 3D model. Then, the content supply unit 342 may supply the content including the motion data having the definition that has been requested based on the control information.

Further, the motion data generation unit 334 may generate variations of the definition of the motion data. Then, the control information generation unit 313 may generate the control information that expresses the generated variations of the definition of the motion data. It is noted that the motion data generation unit 334 may generate the motion data having a lower definition based on the motion data having a highest definition.

It is noted that the control information may be described in glTF2.0. Alternatively, the control information may be MPD. Alternatively, the control information may be Universal Scene Description.

With such a configuration, the distribution device 300 can suppress an increase in the load of the reproduction processing performed by the reproduction device while suppressing lowering of the quality of a user experience.

### <Flow of Distribution Processing>

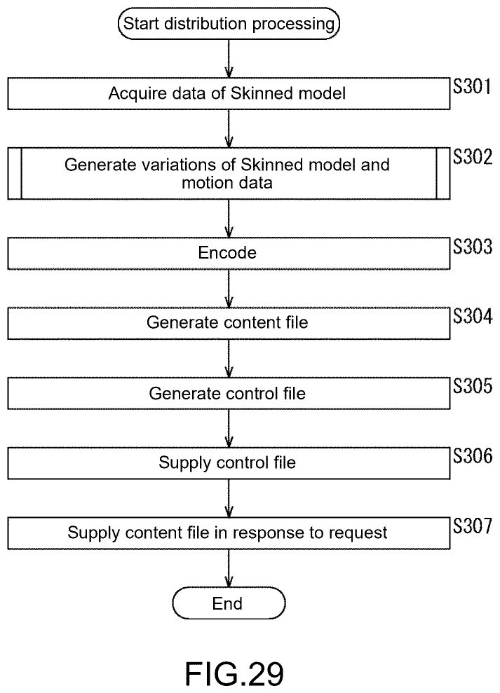

An example of a flow of distribution processing executed by the distribution device 300 having such a configuration by applying Method 1 described above will be described with reference to the flowchart shown in FIG. 29.

When the distribution processing is started, in Step S301, the data input unit 311 of the distribution device 300 acquires data of a Skinned model and/or the like (e.g., skeleton information, static 3D model, skin weight information, and the like).

In Step S302, the data input unit 311 and the preprocessing unit 321 execute generation processing to generate variations of the Skinned model (the static 3D model, the skeleton information, and the skin weight information) and motion data.

In Step S303, the encoding unit 322 encodes content data such as the Skinned model and motion data acquired in Step S301 and the variations of the Skinned model and motion data generated by the generation processing in Step S302, to generate encoded data.

In Step S304, the file generation unit 323 generates a content file by storing the encoded data generated in Step S303 in a file. The storage unit 314 stores the content file.

In Step S305, the control information generation unit 313 generates control information and stores the control information in a control file. The storage unit 314 stores the control file.

In Step S306, the control information supply unit 341 reads out the control file stored in the storage unit 314, and supplies the control file to another device such as the reproduction device that reproduces the content data.

In Step S307, the content supply unit 342 acquires a request for distribution of the content file, that has been supplied from the another device such as the reproduction device that reproduces the content data, reads out the content file storing the content data of the LoD specified in the request from the storage unit 314, and supplies the content file to the another device such as the reproduction device that reproduces the content data.

When the processing of Step S307 ends, the distribution processing ends.

### <Flow of Generation Processing>

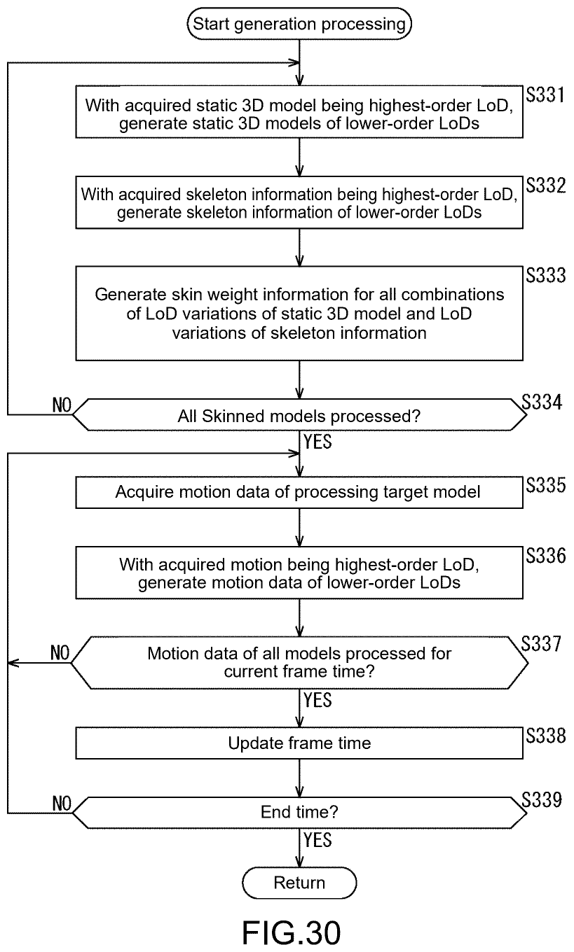

Next, an example of a flow of the generation processing executed in Step S302 in FIG. 29 will be described with reference to the flowchart shown in FIG. 30. It is noted that herein, the Skinned model is described as an avatar that expresses poses and movements of a user in a virtual space. In addition, in the virtual space, the avatar of each user recreates captured movements of that user.

When the generation processing is started, in Step S331, the static 3D model generation unit 331 generates, with the static 3D model acquired in Step S301 of the distribution processing described above being the highest-order LoD, static 3D models of lower-order LoDs using the static 3D model of the highest-order LoD.

In Step S332, the skeleton information generation unit 332 generates, with the skeleton information acquired in Step S301 of the distribution processing described above being the highest-order LoD, skeleton information of lower-order LoDs using the skeleton information of the highest-order LoD.

In Step S333, the skin weight information generation unit 333 generates skin weight information for all combinations of the variations of the LoD (i.e., the definition of the appearance) of the static 3D model and the variations of the LoD (i.e., the definition of the movement structure) of the skeleton information. For example, the skin weight information generation unit 333 may generate variations of the skin weight information using the skin weight information acquired in Step S301 of the distribution processing described above.

In Step S334, the control unit 301 determines whether or not these processing has been executed for all Skinned models (avatars). When it is determined that there is an unprocessed Skinned model, the processing returns to Step S331, and the subsequent processing is repeated. That is, the processing of Steps S331 to S334 is executed for all Skinned models.

Then, when it is determined in Step S334 that there are no unprocessed Skinned models and the processing described above has been completed for all Skinned models, the processing proceeds to Step S335.

In Step S335, the data input unit 311 acquires motion data of a processing target 3D model.

In Step S336, the motion data generation unit 334 generates, with the acquired motion data being the highest-order LoD, motion data of lower-order LoDs using the motion data of the highest LoD.

In Step S337, the control unit 301 determines whether or not the motion data of all 3D models (Skinned models) has been processed for the current frame time. When it is determined that there is an unprocessed 3D model for the current frame time, the processing returns to Step S335, and the subsequent processing is repeated. That is, the processing of Steps S335 to S337 is executed for all 3D models.

Then, when it is determined in Step S337 that there are no unprocessed 3D models and the processing described above has been completed for all 3D models for the current frame time, the processing proceeds to Step S338.

In Step S338, the control unit 301 updates the processing target frame. That is, the control unit 301 updates the time of the frame to be processed (that is, the current frame time).

In Step S339, the control unit 301 determines whether or not the current frame time is an end time. When it is determined that the current frame time as the processing target has not reached the end time, the processing returns to Step S335, and the subsequent processing is repeated. In other words, the processing of Steps S335 to S339 is executed until reaching the end time.

Then, when it is determined in Step S339 that the current frame time has reached the end time, the generation processing ends, and the processing returns to FIG. 29.

In such distribution processing and generation, the present technology described above in <3. Control of definition related to 3D model> may be applied. For example, Method 1 described above may be applied to the distribution device 300.

For example, in Step S306 (FIG. 29), the control information supply unit 341 may supply control information for controlling supply of content including a static 3D model indicating an appearance of a 3D model, skeleton information indicating a movement structure of the 3D model, and skin weight information indicating a correspondence relationship between the appearance and the movement structure. Further, in Step S307 (FIG. 29), the content supply unit 342 may supply the content including the static 3D model having a definition that has been requested based on the control information, the skeleton information having a definition that has been requested based on the control information, and the skin weight information that has been requested based on the control information. It is noted that the control information may express, independently of one another, variations of the definition of the static 3D model, variations of the definition of the skeleton information, and variations of the skin weight information.

By performing each processing as described above, the distribution device 300 can suppress an increase in the load of the reproduction processing performed by the reproduction device while suppressing lowering of the quality of a user experience.

### 5. Second Embodiment

### <Reproduction Device>

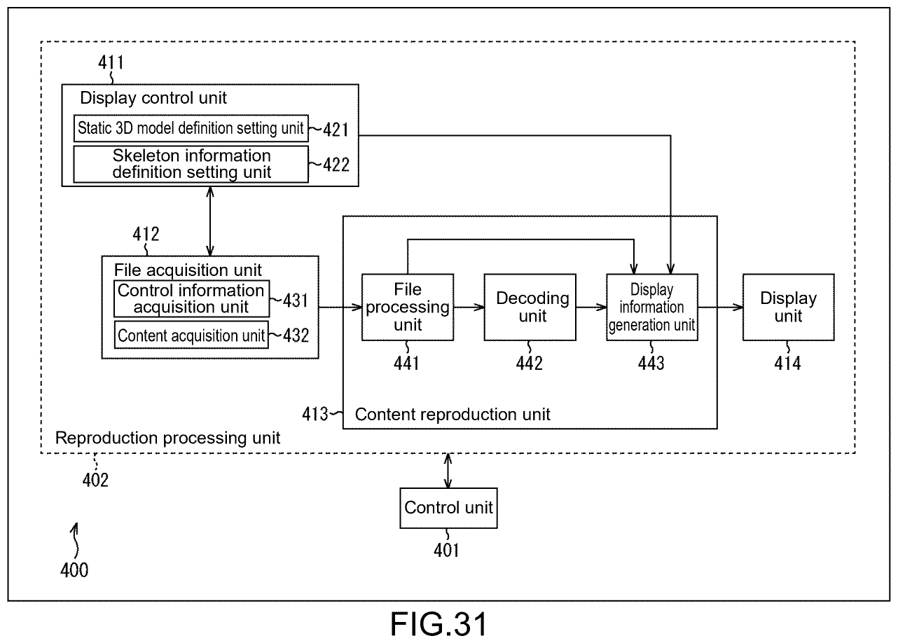

FIG. 31 is a block diagram showing an example of a configuration of the reproduction device, which is one aspect of the information processing apparatus to which the present technology is applied. The reproduction device 400 shown in FIG. 31 is a reproduction device that acquires content data based on control information, and performs reproduction processing of the acquired content data. For example, the reproduction device 400 reproduces content data (Skinned model, motion data, and the like) stored in a content file generated by the distribution device 300. Of course, the reproduction device 400 may also perform other processing.

It is noted that FIG. 31 shows the main processing units, data flows, and the like, and not everything is shown in FIG. 31. In other words, in the reproduction device 400, there may be processing units that are not shown as blocks in FIG. 31, and there may be processing and data flows that are not indicated as arrows and the like in FIG. 31.

As shown in FIG. 31, the reproduction device 400 includes a control unit 401 and a reproduction processing unit 402. The control unit 401 performs processing related to control of each processing unit of the reproduction processing unit 402. The reproduction processing unit 402 performs processing related to reproduction of content data. Of course, the control unit 401 and the reproduction processing unit 402 may also execute other processing.

The reproduction processing unit 402 includes a display control unit 411, a file acquisition unit 412, a content reproduction unit 413, and a display unit 414. Further, the display control unit 411 includes a static 3D model definition setting unit 421 and a skeleton information definition setting unit 422. Further, the file acquisition unit 412 includes a control information acquisition unit 431 and a content acquisition unit 432. Further, the content reproduction unit 413 includes a file processing unit 441, a decoding unit 442, and a display information generation unit 443.

The display control unit 411 executes processing related to the control of image display. For example, the display control unit 411 may control the file acquisition unit 412 to acquire information supplied from another device. For example, the display control unit 411 may cause the control information acquisition unit 431 to acquire and supply control information, to acquire the control information. Further, the display control unit 411 may set definitions of a static 3D model and skeleton information based on the control information. Further, the display control unit 411 may select a variation of skin weight information or set a definition of motion data. Further, the display control unit 411 may cause the content acquisition unit 432 to acquire the static 3D model, skeleton information, skin weight information, motion data, and/or the like of the variation selected in such a manner. Further, the display control unit 411 may control the display information generation unit 443 to generate display information. Of course, the display control unit 411 may also execute other processing.

The file acquisition unit 412 performs processing related to the acquisition of information under control of the display control unit 411. For example, the file acquisition unit 412 may acquire a control file supplied from another device (e.g., distribution device 300). Further, the file acquisition unit 412 may supply the acquired control file to the display control unit 411. Further, the file acquisition unit 412 may supply a request for distribution of a content file storing content data of a desired definition (LoD) to the distribution device 300 under control of the display control unit 411 that is based on the control file. Further, the file acquisition unit 412 may acquire a content file distributed by the distribution device 300 based on the request. Further, the file acquisition unit 412 may supply the acquired content file to the file processing unit 441. Of course, the file acquisition unit 412 may also perform other processing.

The content reproduction unit 413 executes processing related to content. For example, the content reproduction unit 413 may acquire a content file supplied from the file acquisition unit 412. Further, the content reproduction unit 413 may extract content data from the acquired content file and decode the content data, to generate display information. Further, the content reproduction unit 413 may supply the generated display information to the display unit 414 for display. Of course, the content reproduction unit 413 may also execute other processing.

The display unit 414 includes a display device and performs processing related to image display. For example, the display unit 414 may acquire display information supplied from the display information generation unit 443, and display the display information using the display device. Of course, the display unit 414 may also perform other processing, such as displaying other information.

The static 3D model definition setting unit 421 performs processing related to the setting of the definition of the static 3D model. For example, the static 3D model definition setting unit 421 may set the definition of the static 3D model based on control information. Further, the static 3D model definition setting unit 421 may cause the content acquisition unit 432 to acquire the static 3D model having the set definition. Of course, the static 3D model definition setting unit 421 may also execute other processing.

The skeleton information definition setting unit 422 performs processing related to the setting of the definition of the skeleton information. For example, the skeleton information definition setting unit 422 may set the definition of the skeleton information based on control information. Further, the skeleton information definition setting unit 422 may cause the content acquisition unit 432 to acquire the skeleton information having the set definition. Of course, the skeleton information definition setting unit 422 may also execute other processing.

The control information acquisition unit 431 performs processing related to the acquisition of control information. For example, the control information acquisition unit 431 may acquire a control file supplied from outside (e.g., distribution device 300), and provide the control file to the display control unit 411. Of course, the control information acquisition unit 431 may also execute other processing.

The content acquisition unit 432 performs processing related to the acquisition of content. For example, the content acquisition unit 432 may request and acquire a content file from outside (e.g., distribution device 300) under control of the display control unit 411. Further, the content acquisition unit 432 may supply the acquired content file to the file processing unit 441. Of course, the content acquisition unit 432 may also execute other processing.

The file processing unit 441 performs processing related to a content file. For example, the file processing unit 441 may acquire a content file supplied from the file acquisition unit 412. Further, the file processing unit 441 may extract encoded data, metadata, and the like of the content data stored in the acquired content file. Further, the file processing unit 441 may supply the extracted encoded data of the content data to the decoding unit 442. Further, the file processing unit 441 may supply the extracted metadata and/or the like to the display information generation unit 443. Of course, the file processing unit 441 may also execute other processing.

The decoding unit 442 performs processing related to the decoding of encoded data of content data. For example, the decoding unit 442 may acquire encoded data of content data supplied from the file processing unit 441. Further, the decoding unit 442 may decode the encoded data using a predetermined decoding method to generate (restore) the content data. It is noted that this decoding method may be any method as long as it is a method corresponding to the encoding method applied at the time of encoding. Further, the decoding unit 442 may supply the generated content data to the display information generation unit 443. Of course, the decoding unit 442 may also perform other processing.

The display information generation unit 443 executes processing related to the generation of display information to be displayed by the display unit 414. For example, the display information generation unit 443 may acquire content data supplied from the decoding unit 442. Further, the display information generation unit 443 may acquire metadata and/or the like supplied from the file processing unit 441. Further, the display information generation unit 443 may acquire information supplied from the display control unit 411. The display information generation unit 443 may generate display information using the acquired information (content data and the like). For example, the display information generation unit 443 may generate the display information by reproducing content data (3D model) and reconstructing and/or rendering an avatar (object) in the virtual space. Further, the display information generation unit 443 may supply the generated display information to the display unit 414 for display. Of course, the display information generation unit 443 may also execute other processing. It is noted that the display information generation unit 443 may execute some or all of these processing under control of the display control unit 411.

The present technology described above in <3. Control of definition related to 3D model> may be applied to the reproduction device 400 having such a configuration. For example, Method 1 described above may be applied to this reproduction device 400.

For example, the static 3D model definition setting unit 421 may set a definition of a static 3D model indicating an appearance of a 3D model. Further, the skeleton information definition setting unit 422 may set, independently of the static 3D model, a definition of skeleton information indicating a movement structure of the 3D model. Further, the content reproduction unit 413 may reproduce content including the static 3D model and the skeleton information that correspond to the set definitions and skin weight information indicating a correspondence relationship between the appearance and the movement structure.

Further, the static 3D model definition setting unit 421 may set the definition of the static 3D model based on a first parameter, and the skeleton information definition setting unit 422 may set the definition of the skeleton information based on a second parameter different from the first parameter. For example, the second parameter may be a parameter of a type different from that of the first parameter. For example, the first parameter may be a parameter related to a distance from a viewpoint position to the 3D model, and the second parameter may be a parameter related to the content that is different from the distance. Alternatively, the first parameter may be a parameter related to the distance from the viewpoint position to the 3D model, and the second parameter may be a parameter related to a load of the content reproduction processing. Alternatively, the second parameter may be a parameter having a value different from that of the first parameter. Alternatively, the second parameter may be a parameter of a timing different from that of the first parameter.

Further, the control information acquisition unit 431 may acquire control information for controlling supply of content. Then, the static 3D model definition setting unit 421 may set the definition of the static 3D model based on the acquired control information. Further, the skeleton information definition setting unit 422 may set, independently of the static 3D model, the definition of the skeleton information based on the acquired control information. Further, the content acquisition unit 432 may acquire, as the content, the static 3D model and the skeleton information having the definitions set independently of each other and the skin weight information corresponding to the static 3D model and the skeleton information, based on the control information. Then, the content reproduction unit 413 may reproduce the acquired content.

It is noted that this control information may be described in lTF2.0. Alternatively, this control information may be MPD. Alternatively, this control information may be Universal Scene Description.

Further, the content reproduction unit 413 may reproduce the content further including motion data indicating a movement of the 3D model. The definition of the motion data may correspond to the definition of the skeleton information. Further, the content acquisition unit 432 may acquire the static 3D model, the skeleton information, the motion data, and the skin weight information as the content. Then, the content reproduction unit 413 may reproduce the acquired content.

With such a configuration, the reproduction device 400 can control the definitions of the static 3D model and the skeleton information independently of each other. Therefore, the reproduction device 400 can suppress an increase in the load of the reproduction processing while suppressing lowering of the quality of a user experience.

### <Flow of Reproduction Processing>

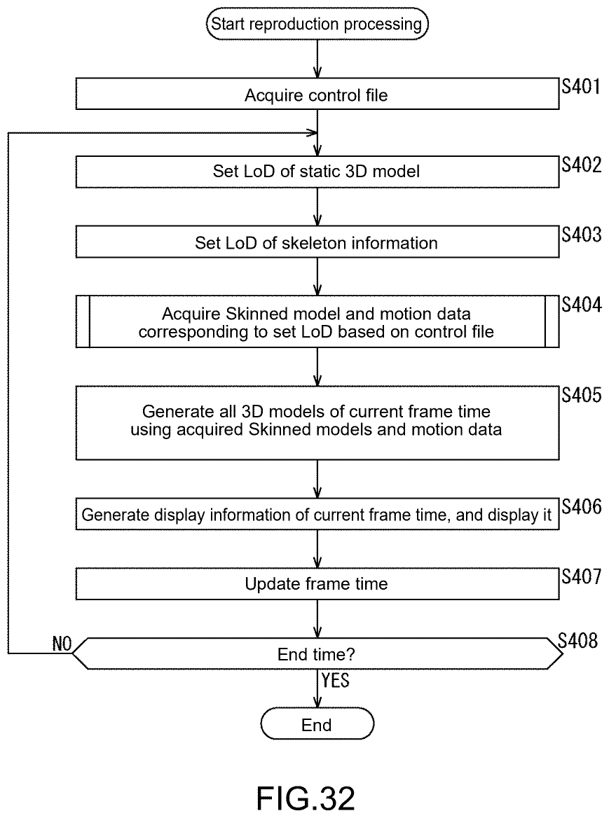

An example of a flow of the reproduction processing executed by the reproduction device 400 having such a configuration by applying Method 1 described above will be described with reference to the flowchart shown in FIG. 32. It is noted that herein, descriptions will be given assuming that an object indicated by a Skinned model is an avatar that expresses poses and movements of the user in the virtual space.

When the reproduction processing is started, in Step S401, the control information acquisition unit 431 of the reproduction device 400 acquires a control file. In this control file, variations of the definition of the static 3D model, variations of the definition of the skeleton information, and variations of the skin weight information are expressed independently of one another.

In Step S402, the static 3D model definition setting unit 421 sets the LoD of the static 3D model (the definition of the appearance) that is requested to be supplied from the distribution device 300.

In Step S403, the skeleton information definition setting unit 422 sets the LoD of the skeleton information (the definition of the movement structure) that is requested to be supplied from the distribution device 300. The skeleton information definition setting unit 422 performs this setting independently of the setting of the definition of the static 3D model.

In Step S404, the content acquisition unit 432 executes acquisition processing to acquire a Skinned model and motion data corresponding to the LoD set as described above under control of the display control unit 411.

In Step S405, the content reproduction unit 413 generates all 3D models of the current frame time using the Skinned models and motion data acquired by the processing of Step S404.

In Step S406, the display information generation unit 443 generates display information of the current frame time generated by the processing of Step S405. The display unit 414 displays the display information.

In Step S407, the control unit 401 updates the frame time.

In Step S408, the control unit 401 determines whether or not the current frame time is the end time. When it is determined that the current frame time is not the end time, the processing returns to Step S402, and the subsequent processing is repeated. On the other hand, when it is determined in Step S408 that the current frame time has reached the end time, the reproduction processing ends.

### <Acquisition Processing Flow 1>

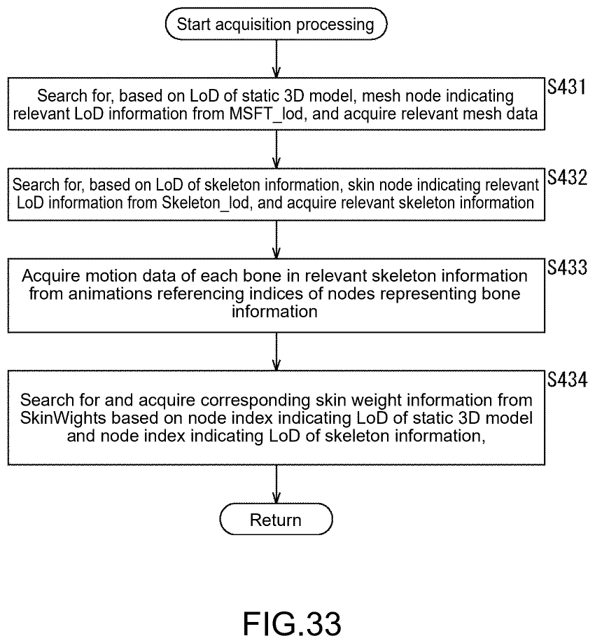

Next, an example of a flow of the acquisition processing executed in Step S404 in FIG. 32 will be described with reference to the flowchart shown in FIG. 33. In this flowchart, an example in which control information is described in glTF2.0 will be described.

When the acquisition processing is started, in Step S431, the content acquisition unit 432 searches for, based on the LoD of the static 3D model, a mesh node indicating relevant LoD information (the LoD set in Step S402) from MSFT_lod, and acquires relevant mesh data.

In Step S432, the content acquisition unit 432 searches for, based on the LoD of the skeleton information, a skin node indicating relevant LoD information (the LoD set in Step S403) from Skeleton_lod, and acquires relevant skeleton information.

In Step S433, the content acquisition unit 432 acquires motion data of each bone in the relevant skeleton information from animations referencing indices of nodes representing bone information.

In Step S434, the content acquisition unit 432 searches for and acquires corresponding skin weight information from SkinWeights based on the node index indicating the LOD of the static 3D model and the node index indicating the LoD of the skeleton information.

When the processing of Step S434 ends, the acquisition processing ends, and the processing returns to FIG. 32.

### <Acquisition Processing Flow 2>

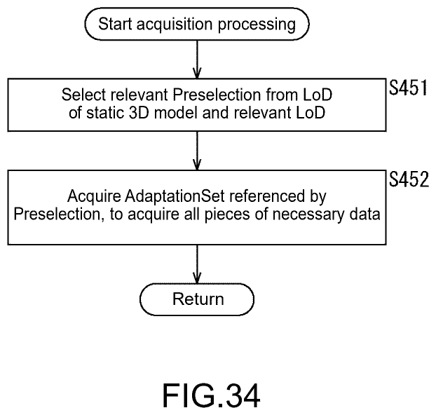

Next, an example of a flow of the acquisition processing in a case where the control information is described in MPD will be described with reference to the flowchart shown in FIG. 34.

When the acquisition processing is started, in Step S451, the content acquisition unit 432 selects a relevant preselection (Preselection) from the LoD of the static 3D model and the relevant LoD.

In Step S452, the content acquisition unit 432 acquires the adaptation set referenced by the preselection, to acquire all pieces of necessary data (the skeleton information, static 3D model, skin weight information, motion data, and/or the like of a desired LoD).

When the processing of Step S452 ends, the acquisition processing ends, and the processing returns to FIG. 32.

### <Acquisition Processing Flow 3>

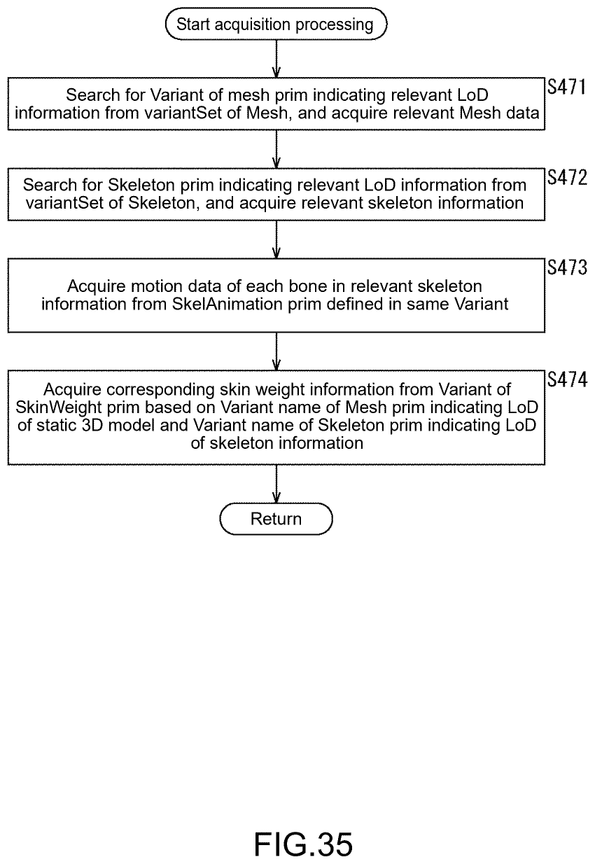

Next, an example of a flow of the acquisition processing in a case where the control information is described in USD will be described with reference to the flowchart shown in FIG. 35.

When the acquisition processing is started, in Step S471, the content acquisition unit 432 searches for Variant of a mesh prim indicating relevant LoD information from variantSet of Mesh, and acquires relevant mesh data.

In Step S472, the content acquisition unit 432 searches for a Skeleton prim indicating relevant LoD information from variantSet of Skeleton, and acquires relevant skeleton information.

In Step S473, the content acquisition unit 432 acquires motion data of each bone in the relevant skeleton information from the SkelAnimation prim defined in the same Variant.

In Step S474, the content acquisition unit 432 acquires corresponding skin weight information from Variant of the SkinWeight prim based on the Variant name of the Mesh prim indicating the LoD of the static 3D model and the Variant name of the Skeleton prim indicating the LoD of the skeleton information.

When the processing of Step S474 ends, the acquisition processing ends, and the processing returns to FIG. 32.

In such reproduction processing and acquisition processing, the present technology described above in <3. Control of definition related to 3D model> may be applied. For example, Method 1 described above may be applied to this reproduction device 400.

For example, in Step S402 (FIG. 32), the static 3D model definition setting unit 421 may set a definition of a static 3D model indicating an appearance of a 3D model. Further, in Step S403 (FIG. 32), the skeleton information definition setting unit 422 may set, independently of the static 3D model, a definition of skeleton information indicating a movement structure of the 3D model. Further, in Steps S405 and S406 (FIG. 32), the content reproduction unit 413 may reproduce content including the static 3D model and the skeleton information that correspond to the set definitions and skin weight information indicating a correspondence relationship between the appearance and the movement structure.

By executing each processing as described above, the reproduction device 400 can control the definitions of the static 3D model and the skeleton information independently of each other. Therefore, the reproduction device 400 can suppress an increase in the load of the reproduction processing while suppressing lowering of the quality of a user experience.

### 6. Notes

### <Computer>

The series of processing described above can be executed by hardware or can be executed by software. When the series of processing is executed by software, a program configuring the software is installed in a computer. Herein, the computer includes a computer incorporated into dedicated hardware, a general-purpose personal computer, for example, that is capable of installing various programs therein to execute various functions, and the like.

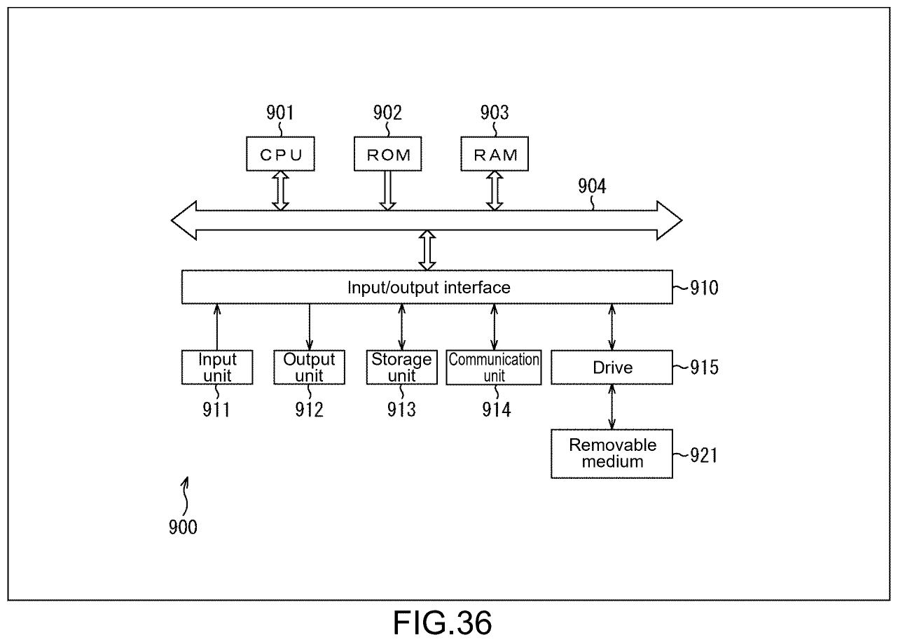

FIG. 36 is a block diagram showing a hardware configuration example of a computer that executes the series of processing described above by a program.

In a computer 900 shown in FIG. 36, a CPU (Central Processing Unit) 901, a ROM (Read Only Memory) 902, and a RAM (Random Access Memory) 903 are mutually connected via a bus 904.

An input/output interface 910 is also connected to the bus 904. Connected to the input/output interface 910 are an input unit 911, an output unit 912, a storage unit 913, a communication unit 914, and a drive 915.

The input unit 911 is constituted of, for example, a keyboard, a mouse, a microphone, a touch panel, an input terminal, and the like. The output unit 912 is constituted of, for example, a display, a speaker, an output terminal, and the like. The storage unit 913 is constituted of, for example, a hard disk, a RAM disk, a nonvolatile memory, and the like. The communication unit 914 is constituted of, for example, a network interface. The drive 915 drives a removable medium 921 such as a magnetic disc, an optical disc, a magneto optical disc, or a semiconductor memory.

In the computer configured as described above, the CPU 901 loads a program stored in the storage unit 913 into the RAM 903 via the input/output interface 910 and the bus 904 and executes it, to carry out the series of processing described above, for example. Data required for the CPU 901 to execute various types of processing, and the like are also stored in the RAM 903 as appropriate.

The program executed by the computer can be applied by being recorded onto the removable medium 921 as a package medium or the like, for example. In that case, the program can be installed in the storage unit 913 via the input/output interface 910 by loading the removable medium 921 into the drive 915.

Further, this program can also be provided via wired or wireless transmission media such as a local area network, the Internet, and digital satellite broadcasting. In that case, the program can be received by the communication unit 914 to be installed in the storage unit 913.

Alternatively, this program can be installed in advance in the ROM 902 or the storage unit 913.

### <Application Target of Present Technology>

The present technology can be applied to arbitrary configurations. For example, the present technology may be applied to various electronic apparatuses.

Moreover, for example, the present technology can be executed as a partial configuration of an apparatus, such as a processor as a system LSI (Large Scale Integration) or the like (e.g., video processor), a module that uses a plurality of processors and the like (e.g., video module), a unit that uses a plurality of modules and the like (e.g., video unit), or a set obtained by adding other functions to the unit (e.g., video set).

Further, for example, the present technology can also be applied to a network system constituted of a plurality of apparatuses. For example, the present technology may be executed as cloud computing in which a plurality of apparatuses share and cooperate to process via a network. For example, the present technology may be executed in, for example, a cloud service that provides a service related to images (moving images) to an arbitrary terminal such as a computer, an AV (Audio Visual) apparatus, a mobile information processing terminal, and an IoT (Internet of Things) device.

It is noted that in the present specification, the system refers to an aggregation of a plurality of constituent elements (apparatuses, modules (components), and the like), and whether or not all of the constituent elements are within the same housing is irrelevant. Accordingly, a plurality of apparatuses that are housed in separate housings and are connected via a network and a single apparatus in which a plurality of modules are housed in a single housing are both systems.

<Fields/Uses to which Present Technology can be Applied>

The systems, apparatuses, processing units, and the like to which the present technology is applied can be used in arbitrary fields of, for example, traffic, medical care, crime prevention, agriculture, livestock business, mining, beauty care, industrial plants, home electrical appliance, weather, natural surveillance, and the like. In addition, uses thereof are also arbitrary.

### <Others>

It is noted that “flag” used in the present specification is information for identifying a plurality of states and includes not only information used when identifying two states of true (1) and false (0) but also information with which three or more states can be identified. Accordingly, values that this “flag” may take may be, for example, binary as in 1/0 or ternary or more. In other words, a bit count configuring this “flag” is arbitrary and may be 1 bit or a plurality of bits. Further, since identification information (including the flag) may take not only a form in which the identification information is incorporated in a bit stream but also a form in which differential information of the identification information with respect to certain information that becomes a reference is incorporated in a bit stream, in the present specification, the “flag” or “identification information” includes not only that information but also differential information with respect to information that becomes a reference.

In addition, various types of information (metadata etc.) related to encoded data (bit stream) may be transmitted or recorded in any form as long as the information is associated with the encoded data. Herein, the term “associate” means enabling, when processing one of the data, the other data to be used (to be linked). In other words, the data associated with each other may be compiled as one piece of data or may each be regarded as individual data. For example, information associated with encoded data (image) may be transmitted on a transmission path different from that of the encoded data (image). Further, for example, information associated with encoded data (image) may be recorded on a recording medium different from that of the encoded data (image) (or in a different recording area in the same recording medium). It is noted that this “associate” may be applied to not only the entire data but also a part of the data. For example, an image and information corresponding to the image may be associated with each other in an arbitrary unit including a plurality of frames, one frame, one portion in a frame, or the like.

It is noted that in the present specification, the terms “synthesize”, “multiplex”, “add”, “integrate”, “incorporate”, “store”, “put into”, “inset”, “insert”, and the like mean compiling a plurality of objects into one, such as compiling encoded data and metadata into one piece of data, for example, and refer to one method of “associate” described above.

Further, embodiments of the present technology are not limited to the embodiments described above and can be variously modified without departing from the gist of the present technology.

For example, the configuration described as one apparatus (or processing unit) may be divided to be configured as a plurality of apparatuses (or processing units). Conversely, the configuration described above as a plurality of apparatuses (or processing units) may collectively be configured as one apparatus (or processing unit). Furthermore, configurations other than those described above may of course be added to the configurations of the respective apparatuses (or the respective processing units). In addition, as long as configurations and operations as the entire system are substantially the same, a part of a configuration of a certain apparatus (or processing unit) may be incorporated into a configuration of another apparatus (or another processing unit).

Furthermore, for example, the program described above may be executed in an arbitrary apparatus. In that case, the apparatus only needs to have necessary functions (functional blocks etc.) so as to be capable of acquiring necessary information.

Moreover, for example, respective steps of a single flowchart may be executed by a single apparatus, or may be shared by a plurality of apparatuses to be executed. In addition, when a plurality of processing is included in a single step, the plurality of processing may be executed by a single apparatus, or may be shared by a plurality of apparatuses to be executed. In other words, the plurality of processing included in a single step can be executed as processing of a plurality of steps. Conversely, processing described as a plurality of steps can collectively be executed as a single step.

Furthermore, for example, regarding the program executed by the computer, the processing of the steps describing the program may be executed in time series in the order described in the present specification, or may be executed in parallel or individually at necessary timings, such as when invoked. In other words, as long as no contradiction is caused, the processing of the respective steps may be executed in an order different from the order described above. In addition, the processing of the steps describing the program may be executed in parallel with processing of other programs, or may be executed in combination with the processing of other programs.

Further, for example, as long as no contradiction is caused, the plurality of technical elements included in the present technology can each be executed independently and individually. Of course, a plurality of arbitrary technical elements out of the plurality of technical elements can be executed in combination. For example, a part or all of the present technology described in any of the embodiments can be executed in combination with a part or all of the present technology described in the other embodiments. Moreover, a part or all of the arbitrary present technology described above can be executed in combination with other technologies not described above.

It is noted that the present technology can also take the following configurations.
(1) An information processing apparatus, including:
   a control information supply unit which supplies control information for controlling supply of content including a static 3D model indicating an appearance of a 3D model, skeleton information indicating a movement structure of the 3D model, and skin weight information indicating a correspondence relationship between the appearance and the movement structure; and
   a content supply unit which supplies the content including the static 3D model having a definition that has been requested based on the control information, the skeleton information having a definition that has been requested based on the control information, and the skin weight information that has been requested based on the control information, in which
   the control information expresses, independently of one another, variations of the definition of the static 3D model, variations of the definition of the skeleton information, and variations of the skin weight information.
(2) The information processing apparatus according to (1), further including:
   a control information generation unit which generates the control information based on the content, in which
   the control information supply unit is configured to supply the generated control information.
(3) The information processing apparatus according to (2), further including:
   a static 3D model generation unit which generates the variations of the definition of the static 3D model, in which
   the control information generation unit is configured to generate the control information that expresses the generated variations of the definition of the static 3D model.
(4) The information processing apparatus according to (3), in which
   the static 3D model generation unit generates the static 3D model having a lower definition based on the static 3D model having a highest definition.
(5) The information processing apparatus according to any one of (2) to (4), further including:
   a skeleton information generation unit which generates the variations of the definition of the skeleton information, in which
   the control information generation unit is configured to generate the control information that expresses the generated variations of the definition of the skeleton information.
(6) The information processing apparatus according to (5), in which
   the skeleton information generation unit generates the skeleton information having a lower definition based on the skeleton information having a highest definition.
(7) The information processing apparatus according to any one of (2) to (6), further including:
   a skin weight information generation unit which generates the variations of the skin weight information based on the variations of the definition of the static 3D model and the variations of the definition of the skeleton information, in which
   the control information generation unit is configured to generate the control information that expresses the generated variations of the skin weight information.
(8) The information processing apparatus according to (7), in which
   the skin weight information generation unit generates the skin weight information having a content corresponding to a case where at least one of the static 3D model or the skeleton information has the lower definition, based on the skin weight information having a content corresponding to a case where the static 3D model and the skeleton information have the highest definitions.
(9) The information processing apparatus according to any one of (2) to (8), in which
   the control information further expresses variations of a definition of motion data indicating a movement of the 3D model, and
   the content supply unit is configured to supply the content including the motion data having the definition that has been requested based on the control information.
(10) The information processing apparatus according to (9), further including:
   a motion data generation unit which generates variations of the definition of the motion data, in which
   the control information generation unit is configured to generate the control information that expresses the generated variations of the definition of the motion data.
(11) The information processing apparatus according to (10), in which
   the motion data generation unit generates the motion data having a lower definition based on the motion data having a highest definition.
(12) The information processing apparatus according to any one of (1) to (11), in which
   the control information is described in glTF2.0.
(13) The information processing apparatus according to any one of (1) to (11), in which
   the control information is MPD (Media Presentation Description).
(14) The information processing apparatus according to any one of (1) to (11), in which
   the control information is Universal Scene Description.
(15) An information processing method, including:
   supplying control information for controlling supply of content including a static 3D model indicating an appearance of a 3D model, skeleton information indicating a movement structure of the 3D model, and skin weight information indicating a correspondence relationship between the appearance and the movement structure; and
   supplying the content including the static 3D model having a definition that has been requested based on the control information, the skeleton information having a definition that has been requested based on the control information, and the skin weight information that has been requested based on the control information, in which
   the control information expresses, independently of one another, variations of the definition of the static 3D model, variations of the definition of the skeleton information, and variations of the skin weight information.
(21) An information processing apparatus, including:
   a static 3D model definition setting unit which sets a definition of a static 3D model indicating an appearance of a 3D model;
   a skeleton information definition setting unit which sets, independently of the static 3D model, a definition of skeleton information indicating a movement structure of the 3D model; and
   a content reproduction unit which reproduces content including the static 3D model and the skeleton information that correspond to the set definitions and skin weight information indicating a correspondence relationship between the appearance and the movement structure.
(22) The information processing apparatus according to (21), in which
   the static 3D model definition setting unit sets the definition of the static 3D model based on a first parameter, and
   the skeleton information definition setting unit sets the definition of the skeleton information based on a second parameter different from the first parameter.
(23) The information processing apparatus according to (22), in which
   the second parameter is a parameter of a type different from that of the first parameter.
(24) The information processing apparatus according to (23), in which
   the first parameter is a parameter related to a distance from a viewpoint position to the 3D model, and
   the second parameter is a parameter related to the content that is different from the distance.
(25) The information processing apparatus according to (23), in which
   the first parameter is a parameter related to a distance from a viewpoint position to the 3D model, and
   the second parameter is a parameter related to a load of reproduction processing of the content.
(26) The information processing apparatus according to (22), in which
   the second parameter is a parameter having a value different from that of the first parameter.
(27) The information processing apparatus according to (22), in which
   the second parameter is a parameter of a timing different from that of the first parameter.
(28) The information processing apparatus according to any one of (21) to (27), further including:
   a control information acquisition unit which acquires control information for controlling supply of the content, in which
   the static 3D model definition setting unit is configured to set the definition of the static 3D model based on the control information, and
   the skeleton information definition setting unit is configured to set, independently of the static 3D model, the definition of the skeleton information based on the control information.
(29) The information processing apparatus according to (28), further including:
   a content acquisition unit which acquires, as the content, the static 3D model and the skeleton information having the definitions set independently of each other and the skin weight information corresponding to the static 3D model and the skeleton information, in which
   the content reproduction unit is configured to reproduce the acquired content.
(30) The information processing apparatus according to (28) or (29), in which
   the control information is described in glTF2.0.
(31) The information processing apparatus according to (28) or (29), in which
   the control information is MPD (Media Presentation Description).
(32) The information processing apparatus according to (28) or (29), in which
   the control information is Universal Scene Description.
(33) The information processing apparatus according to any one of (21) to (32), in which
   the content reproduction unit reproduces the content further including motion data indicating a movement of the 3D model.
(34) The information processing apparatus according to (33), in which
   a definition of the motion data corresponds to the definition of the skeleton information.
(35) The information processing apparatus according to (34), further including:
   a content acquisition unit which acquires, as the content, the static 3D model, the skeleton information, the motion data, and the skin weight information, in which
   the content reproduction unit is configured to reproduce the acquired content.
(36) An information processing method, including:
   setting a definition of a static 3D model indicating an appearance of a 3D model;
   setting, independently of the static 3D model, a definition of skeleton information indicating a movement structure of the 3D model; and
   reproducing content including the static 3D model and the skeleton information that correspond to the set definitions and skin weight information indicating a correspondence relationship between the appearance and the movement structure.

Reference Signs List

| | |
|---|---|
| 300 | distribution device |
| 301 | control unit |
| 302 | distribution processing unit |
| 311 | data input unit |
| 312 | content processing unit |
| 313 | control information generation unit |
| 314 | storage unit |
| 315 | supply unit |
| 321 | preprocessing unit |
| 322 | encoding unit |
| 323 | file generation unit |
| 331 | static 3D model generation unit |
| 332 | skeleton information generation unit |
| 333 | skin weight information generation unit |
| 334 | motion data generation unit |
| 341 | control information supply unit |
| 342 | content supply unit |
| 400 | reproduction device |
| 401 | control unit |
| 402 | reproduction processing unit |
| 411 | display control unit |
| 412 | file acquisition unit |
| 413 | content reproduction unit |
| 414 | display unit |
| 421 | static 3D model definition setting unit |
| 422 | skeleton information definition setting unit |
| 431 | control information acquisition unit |
| 432 | content acquisition unit |
| 441 | file processing unit |
| 442 | decoding unit |
| 443 | display information generation unit |
| 900 | computer |

1. An information processing apparatus, comprising:
a control information supply unit which supplies control information for controlling supply of content including a static 3D model indicating an appearance of a 3D model, skeleton information indicating a movement structure of the 3D model, and skin weight information indicating a correspondence relationship between the appearance and the movement structure; and
a content supply unit which supplies the content including the static 3D model having a definition that has been requested based on the control information, the skeleton information having a definition that has been requested based on the control information, and the skin weight information that has been requested based on the control information, wherein
the control information expresses, independently of one another, variations of the definition of the static 3D model, variations of the definition of the skeleton information, and variations of the skin weight information.

2. The information processing apparatus according to claim 1, further comprising:
a control information generation unit which generates the control information based on the content, wherein
the control information supply unit is configured to supply the generated control information.

3. The information processing apparatus according to claim 2, further comprising:
a static 3D model generation unit which generates the variations of the definition of the static 3D model, wherein
the control information generation unit is configured to generate the control information that expresses the generated variations of the definition of the static 3D model.

4. The information processing apparatus according to claim 2, further comprising:
a skeleton information generation unit which generates the variations of the definition of the skeleton information, wherein
the control information generation unit is configured to generate the control information that expresses the generated variations of the definition of the skeleton information.

5. The information processing apparatus according to claim 2, further comprising:
a skin weight information generation unit which generates the variations of the skin weight information based on the variations of the definition of the static 3D model and the variations of the definition of the skeleton information, wherein
the control information generation unit is configured to generate the control information that expresses the generated variations of the skin weight information.

6. The information processing apparatus according to claim 2, wherein
the control information further expresses variations of a definition of motion data indicating a movement of the 3D model, and
the content supply unit is configured to supply the content including the motion data having the definition that has been requested based on the control information.

7. The information processing apparatus according to claim 1, wherein
the control information is described in glTF2.0.

8. The information processing apparatus according to claim 1, wherein
the control information is MPD (Media Presentation Description).

9. The information processing apparatus according to claim 1, wherein
the control information is Universal Scene Description.

10. An information processing method, comprising:
supplying control information for controlling supply of content including a static 3D model indicating an appearance of a 3D model, skeleton information indicating a movement structure of the 3D model, and skin weight information indicating a correspondence relationship between the appearance and the movement structure; and
supplying the content including the static 3D model having a definition that has been requested based on the control information, the skeleton information having a definition that has been requested based on the control information, and the skin weight information that has been requested based on the control information, wherein
the control information expresses, independently of one another, variations of the definition of the static 3D model, variations of the definition of the skeleton information, and variations of the skin weight information.

11. An information processing apparatus, comprising:
a static 3D model definition setting unit which sets a definition of a static 3D model indicating an appearance of a 3D model;
a skeleton information definition setting unit which sets, independently of the static 3D model, a definition of skeleton information indicating a movement structure of the 3D model; and
a content reproduction unit which reproduces content including the static 3D model and the skeleton information that correspond to the set definitions and skin weight information indicating a correspondence relationship between the appearance and the movement structure.

12. The information processing apparatus according to claim 11, wherein
the static 3D model definition setting unit sets the definition of the static 3D model based on a first parameter, and
the skeleton information definition setting unit sets the definition of the skeleton information based on a second parameter different from the first parameter.

13. The information processing apparatus according to claim 12, wherein
the second parameter is a parameter of a type different from that of the first parameter.

14. The information processing apparatus according to claim 13, wherein
the first parameter is a parameter related to a distance from a viewpoint position to the 3D model, and
the second parameter is a parameter related to the content that is different from the distance.

15. The information processing apparatus according to claim 13, wherein
the first parameter is a parameter related to a distance from a viewpoint position to the 3D model, and
the second parameter is a parameter related to a load of reproduction processing of the content.

16. The information processing apparatus according to claim 11, further comprising:
a control information acquisition unit which acquires control information for controlling supply of the content, wherein
the static 3D model definition setting unit is configured to set the definition of the static 3D model based on the control information, and
the skeleton information definition setting unit is configured to set, independently of the static 3D model, the definition of the skeleton information based on the control information.

17. The information processing apparatus according to claim 16, further comprising:
a content acquisition unit which acquires, as the content, the static 3D model and the skeleton information having the definitions set independently of each other and the skin weight information corresponding to the static 3D model and the skeleton information, wherein
the content reproduction unit is configured to reproduce the acquired content.

18. The information processing apparatus according to claim 11, wherein
the content reproduction unit reproduces the content further including motion data indicating a movement of the 3D model.

19. The information processing apparatus according to claim 18, wherein
a definition of the motion data corresponds to the definition of the skeleton information.

20. An information processing method, comprising:
setting a definition of a static 3D model indicating an appearance of a 3D model;
setting, independently of the static 3D model, a definition of skeleton information indicating a movement structure of the 3D model; and
reproducing content including the static 3D model and the skeleton information that correspond to the set definitions and skin weight information indicating a correspondence relationship between the appearance and the movement structure.
